(19) United States
(12) Patent Application Publication
(10) Pub. No.: US 2025/0287077 A1
(43) Pub. Date: Sep. 11, 2025

(54) CUSTOMIZABLE SYSTEM FOR MANAGING PERSONALIZED COMMUNICATIONS USING AI-GENERATED VIDEO

(71) Applicant: Robert Miglani, Monroe Township, NJ (US)

(72) Inventor: Robert Miglani, Monroe Township, NJ (US)

(21) Appl. No.: 19/070,337

(22) Filed: Mar. 4, 2025

Related U.S. Application Data
(60) Provisional application No. 63/561,611, filed on Mar. 5, 2024.

(51) Int. Cl. H04N 21/81; H04N 21/466

(52) U.S. Cl. CPC H04N 21/816; H04N 21/4666; H04N 21/8106

(57) ABSTRACT

Systems and methods for generating customized media content are provided. Data regarding engagement with customized media content may be tracked and used to train a neural network to generate a content generation module that optimize for increased engagement by adjusting parameters (weights). A new content generation module may be generated by the trained neural network based on a selected set of content attributes and generative artificial intelligence (AI) protocols. New customized media content may thereafter be generated by using the new video content generation module to incorporate multi-modal fusion of facial expression data into video content for the new customized media content based on the selected set of content attributes, use voice matching algorithms to generate an audio track for the video content, synchronize the audio track to the video content, and integrate one or more of the selected set of content attributes into the new customized media content.

### CROSS-REFERENCE TO RELATED APPLICATIONS

The present patent application claims the priority benefit of U.S. provisional application 63/561,611 filed Mar. 5, 2024, the disclosure of which is incorporated herein by reference.

### BACKGROUND OF THE INVENTION

### 1. Field of the Disclosure

The present disclosure is generally related to communication automation platforms, and more particularly, to a customizable communication automation platform including AI-generated video.

### 2. Description of the Related Art

Many businesses require communicating with various parties, each of which may be associated with different types of communication systems and devices. In particular, medical practices of eye care practitioners, physical therapists, dermatologists, and other private healthcare professionals face significant challenges in communicating effectively, in a timely, and/or personalized manner. Existing solutions often fall short, either being too generic or too expensive for small practices to afford. This creates a need for a more tailored approach that can cater specifically to the unique needs of each practice.

Myopia care is a critical service provided by eye care professionals, particularly for children referred by general practitioners. However, many patients and parents often rely on their own research due to a lack of accessible information from eye care professionals themselves. This results in missed appointments and inadequate treatment, underscoring the importance of effective communication in this domain.

A broader issue exists across various private healthcare practices, where the challenge lies in creating targeted campaigns that increase patient engagement and retention. Effective communication with patients is crucial, yet often hindered by a lack of resources or tailored solutions. Specialist physicians, for example, need to market their services not only to patients but also to other healthcare professionals who refer patients. This highlights a widespread need for a more adaptable and responsive approach in managing personalized patient communications across the healthcare landscape.

### SUMMARY OF THE CLAIMED INVENTION

Disclosed are systems, apparatuses, methods, computer readable medium, and circuits for According to at least one example, a computer-implemented method of generating a customized media message, includes receiving first new patient data, receiving first new analytics data, the first new analytics data including engagement metrics of a customized media message generated based on first historical analytics data and first historical patient data. In some cases, the method includes training a neural network based on the first new patient data and the first new analytics data, where the neural network is adapted to generate video content generation modules that optimize for future engagement by adjusting weights to minimize a divergence between predicted and actual patient response based on incorporated feedback from the first new analytics data to refine understanding of patient behavior and preferences, and iteratively refine optimization parameters through reinforcement learning. In some cases, the method includes updating a dashboard interface based on the first new patient data and the first new analytics data, where the respective updates include a first new set of selectable suggestions for generating a new customized media message, receiving a first selected set of content attributes for generating the new customized media message. In some cases, the method includes generating, using the trained neural network, a new video content generation module based on the selected set of content attributes, where the received selected set are associated with weights for the neural network to utilize generative artificial intelligence (AI) protocols to create the new video content generation module. In some cases, the method includes generating, using the new video content generation module, the new customized media message by incorporating multi-modal fusion of facial expression data from a training database based on at least part of the selected set of content attributes, voice matching algorithms that generate an audio track synchronized to video context, and text-to-video synthesis that integrates at least part of the selected set of content attributes.

The computer-implemented method may also include further includes receiving at least one of second new patient data or second new analytics data including new engagement metrics of the new customized media message, where the patient database includes demographic data and health condition data, and analyzing a set of patient data including at least one of the second new patient data or the second new analytics data for new clustering patterns.

The computer-implemented method may also include further includes determining there are no clustering patterns, fine-tuning the trained neural network based on the second new analytics data, where updates the weights are updated based on the new engagement metrics and the new video content generation module is updated based on the updated weights, and generating, using the updated new video content generation module, an updated customized media message by updating the multi-modal fusion of facial expression data, the voice matching algorithms, and the text-to-video synthesis based on at least part of the updated weights.

The computer-implemented method may also include further includes determining there are new clustering patterns, retraining a neural network based on the new clustering patterns, where the neural network is adapted to generate video content generation modules that optimize for future engagement by adjusting weights to minimize a divergence between predicted and actual patient response based on new incorporated feedback from a segment of patient data to refine understanding of patient behavior and preferences, and iteratively refine optimization parameters through reinforcement learning.

The computer-implemented method may also include further includes updating the dashboard interface based on the segment of patient data, where the respective updates include a second new set of selectable suggestions for generating a second new customized media message, receiving a second selected set of content attributes for generating the second new customized media message, generating, using the retrained neural network, a second new video content generation module based on the second selected set of content attributes, where the received second selected set are associated with second weights for the retrained neural network to utilize the generative artificial intelligence (AI) protocols to create the second new video content generation module, and generating, using the second new video content generation module, the second new customized media message by incorporating new multi-modal fusion of facial expression data from the training database based on at least part of the second selected set of content attributes, voice matching algorithms that generate an audio track synchronized to video context, and text-to-video synthesis that integrates at least part of the second selected set of content attributes.

The computer-implemented method may also include further includes updating the dashboard interface based on the segment of patient data, where the respective updates include a second new set of selectable suggestions for generating a second new customized media message, receiving a second selected set of content attributes for generating the second new customized media message, generating, using the retrained neural network, a second new video content generation module based on the second selected set of content attributes, where the received second selected set are associated with second weights for the retrained neural network to utilize the generative artificial intelligence (AI) protocols to create the second new video content generation module, and generating, using the second new video content generation module, the second new customized media message by incorporating new multi-modal fusion of facial expression data from the training database based on at least part of the second selected set of content attributes, voice matching algorithms that generate an audio track synchronized to video context, and text-to-video synthesis that integrates at least part of the second selected set of content attributes.

The computer-implemented method may also include further includes providing, in the dashboard interface, an input field that receives revisions to text spoken by a virtual personal in the new customized media message, fine-tuning the trained neural network based on received revisions, where updates the weights are updated based on the received revisions and the new video content generation module is updated based on the updated weights, and generating, using the updated new video content generation module, an updated customized media message by updating the multi-modal fusion of facial expression data, the voice matching algorithms, and the text-to-video synthesis based on at least part of the updated weights.

The computer-implemented method may also include further includes providing, in the dashboard interface, an option to adjust a presentation style by a virtual personal in the new customized media message, fine-tuning the trained neural network based on a selected adjustment to the presentation style, where updates the weights are updated based on the selected adjustment and the new video content generation module is updated based on the updated weights, and generating, using the updated new video content generation module, an updated customized media message by updating the multi-modal fusion of facial expression data, the voice matching algorithms, and the text-to-video synthesis based on at least part of the updated weights. The computer-implemented method may also include where the option to adjust is presented alongside a heatmap associated with relevant engagement data based on the patient data. The heatmap may be multi-dimensional that considers at least one of patient engagement, sentiment analysis, emotional resonance, language style, or tone.

The computer-implemented method may also include further includes applying, using a machine-learning model, clustering to heatmap data, detecting outliers in the heatmap data, flagging patients associated with the detected outliers, and providing an option to generate a uniquely tailored media message for the flagged patients.

The computer-implemented method may also include further includes providing, in the dashboard interface, an option to record a voice recording to be spoken by a virtual personal in the new customized media message, converting the voice recording into a set of metadata, processing the set of metadata based on high-dimensional speaker embeddings associated with a target speaker, generating a waveform that represents the acoustic characteristics of the target speaker while preserving phonetic content and prosodic content of the voice recording, fine-tuning the trained neural network based on the waveform, where updates the weights are updated based on the waveform and the new video content generation module is updated based on the updated weights, and generating, using the updated new video content generation module, an updated customized media message by updating the multi-modal fusion of facial expression data, the voice matching algorithms, and the text-to-video synthesis based on at least part of the updated weights. Other technical features may be readily apparent to one skilled in the art from the following figures, descriptions, and claims.

### BRIEF DESCRIPTION OF THE DRAWINGS

Aspects of the present disclosure will be described more fully hereinafter with reference to the accompanying drawings in which like numerals represent like elements throughout the several figures, and in which example aspects of this disclosure are shown. Aspects of the claims may, however, be embodied in many different forms and should not be construed as limited to the aspects as set forth herein. The examples set forth herein are non-limiting examples and are merely examples among other possible examples.

FIG. 1 illustrates a system for managing personalized patient communications in healthcare practices.

FIG. 2 illustrates an example method performed by a control module.

FIG. 3 illustrates an example method performed by a marketing automation module and a messaging module.

FIG. 4 illustrates an example method performed by a content generation module and an analytics module.

FIG. 5 displays an example method performed by a patient module, a voice training module, and a face training module.

FIG. 6 illustrates an example method performed by a video generator module and a transcript generator module.

FIG. 7 illustrates a method for generating a customized media message.

FIG. 8 illustrates a block diagram of an exemplary computing system that may be used to implement an embodiment of the present invention.

FIG. 9 illustrates an example neural network architecture.

### DETAILED DESCRIPTION

Embodiments of the present disclosure will be described more fully hereinafter with reference to the accompanying drawings in which like numerals represent like elements throughout the several figures and in which example embodiments are shown. Embodiments of the claims may, however, be embodied in many different forms and should not be construed as limited to the embodiments set forth herein. The examples set forth herein are non-limiting examples and are merely examples among other possible examples.

Medical practices, such as eye care practitioners, physical therapists, dermatologists, and others, often struggle to market their services effectively and communicate with their patients in a timely and personalized manner. Existing marketing and communications platforms are either too generic or too expensive for small practices to afford. There is a need for a cost-effective and customizable platform that can cater to the specific marketing and communications needs of small private medical practices.

For example, Myopia care is a crucial service that eye care professionals provide to children referred by general practitioners. Myopia patients are typically young, and it is essential for parents or guardians to understand the importance of myopia care. Unfortunately, most websites for private eye care professionals do not have good information on the causes and treatments of myopia care. Worse still, eye care professionals find it challenging to effectively communicate with patients and parents in an engaging and useful way. As a result, patients often have to resort to doing their own research, and many simply never keep up with appointments or receive proper treatment due to the lack of professional, clear, engaging, and informative content that might affect their behavior.

Myopia is a common condition that affects the eyesight of millions of people worldwide, and it is particularly prevalent among children. It is caused by the elongation of the eyeball, which results in light focusing in front of the retina instead of on it. This leads to blurry vision and other visual problems. Myopia can also lead to more severe eye problems later in life, such as glaucoma, cataracts, and retinal detachment.

Given the importance of myopia care for children, it is essential that eye care professionals have access to a platform that allows them to communicate the importance of myopia care to parents and guardians effectively. This platform should also provide comprehensive information on the causes and treatments of myopia care, as well as engaging and informative content that can help parents and guardians understand the importance of myopia care for their children.

The need for a marketing automation platform is not unique to myopia care. There exists a similar need for a marketing automation platform in various other private healthcare practices such as dry eyes, dermatology, physical therapy, nursing homes, mental health and addiction treatment, birth centers, and more. In each of these practices, the challenge is to effectively communicate with patients and create targeted campaigns that increase patient engagement and retention. Moreover, there exists a need for a marketing automation platform that can be adapted to the specific needs and drivers of each private healthcare practice with content and communications that are customized to the domain of care. The marketing automation may aid each practice to create and manage personalized marketing campaigns and patient communications that are tailored to their specific area of practice, leading to better outcomes for patients and ultimately contributing to better overall healthcare. Furthermore, the need for medical care practices to create marketing materials is not exclusive the patient-doctor relationship. Specialist physicians, for example, must market their services to other healthcare professionals, such as primary care physicians, who in turn refer patients to the specialist.

Creating engaging and educational video content can be time consuming for practitioners. Doctors are often not trained actors or spokespersons and may not be the best at recording content. However, many patients may prefer the professional touch of having their own doctor or nurse provide them with information in a digestible style such as an informational video.

As such, there is a need for a customizable system that manages personalized patient communications in healthcare practices by addressing the unique marketing and communication challenges faced by small private medical practices, such as eye care practitioners, physical therapists, dermatologists, and others. By providing a customizable platform that can cater to the specific needs of these practices, the technology described herein enables healthcare professionals to create tailored marketing messages based on each patient's healthcare data. The system improves engagement and retention by delivering personalized communications via preferred channels and offering customizable content suggestions and creation tools. The analytics module may track performance metrics, allowing practitioners to make data-driven decisions and optimize their marketing campaigns for better patient outcomes. Ultimately, this technology provides value to healthcare practices by streamlining their marketing and communication efforts, enhancing patient engagement, and contributing to improved overall healthcare.

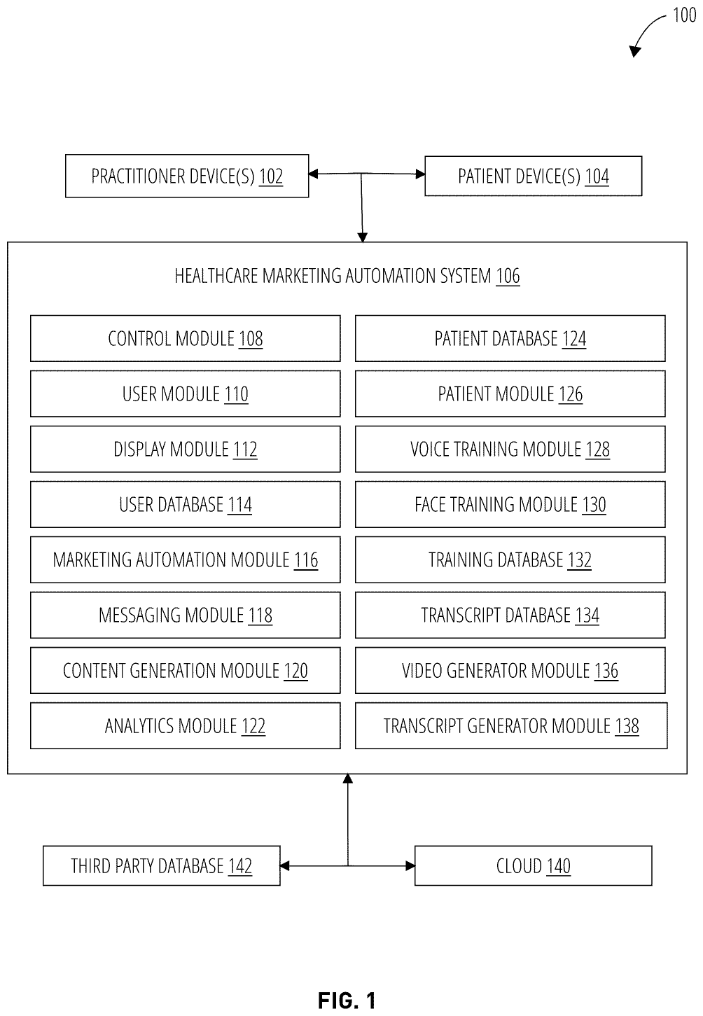

FIG. 1 illustrates a system for managing personalized patient communications in healthcare practices, in an embodiment.

This system comprises practitioner device(s) 102, which are electronic devices used by healthcare professionals to access, input, and manage patient and clinical data in the healthcare marketing automation system and may be, for example, desktop computers, laptop computers, tablet devices, smartphones, and specialized medical equipment with built-in computing capabilities, patient device(s) 104 are electronic devices used by patients to receive personalized communications from healthcare practices through the healthcare marketing automation system and may be, for example, smartphones, personal computers, tablet devices, smartwatches, and other wearable devices, the healthcare marketing automation system 106 is a comprehensive platform designed to facilitate personalized patient communications in healthcare practices by enabling automated marketing and communication between practitioner devices and patient devices. For the purposes of this technology, patient device may also refer to the device of another healthcare provider to whom healthcare services are being marketed.

For example, specialist physicians may wish to market their services to other healthcare professionals, such as primary care physicians, who in turn refer patients to the specialist, in such examples, the primary care physician may utilize patient device(s) 104 to receive messages from the system. Healthcare professionals use practitioner device(s) 102, such as desktop computers or tablets, to access and input patient and clinical data into the system. The data is then utilized by the marketing automation module to create tailored marketing messages based on each patient's healthcare data. These tailored marketing messages serve as personalized communications sent to patients via the messaging module, which delivers the content through the patient's preferred channels, such as email or SMS, to patient devices like smartphones or personal computers. Patients can then engage with the content, schedule appointments, and manage their healthcare information using their devices.

The system 100 also includes content generation, analytics, and patient data control modules that collaborate to provide customizable content, track performance metrics, and store essential patient data, respectively. The control module 108 serves as the central hub for the healthcare marketing automation system 106, coordinating various modules and functionalities to deliver a seamless user experience. It receives user input from practitioners via the user module 110, allowing them to manage patient data and customize marketing campaigns. The control module 108 displays information to the user through the display module 112, providing an interface for navigation and interaction with the healthcare marketing automation system 106. The control module 108 is responsible for storing and retrieving user data from the user database 114, ensuring that healthcare professionals' preferences, settings, and other relevant information are readily accessible. It connects with the marketing automation module 116 to create automated, customizable marketing campaigns tailored to the patients' healthcare journey stages. The messaging module 118 is executed by the control module 108 to send automated, customizable messages to patients using their preferred communication channels. Additionally, the control module 108 executes the content generation module 120, which generates customizable content for marketing campaigns and messages, ensuring that communications are engaging and informative.

The analytics module 122 is also executed by the control module 108 to analyze engagement and other metrics associated with campaigns and messages, providing valuable insights for healthcare professionals to optimize their marketing strategies. Control module 108 retrieves and stores patient data from the patient database 124, allowing practitioners to access and manage essential patient information, such as personal details, clinical data, and appointment history. The user module 110 is a component of the healthcare marketing automation system 106. It provides healthcare professionals with an interface for accessing and managing system functionalities. Practitioners log into the user module 110 to access patient information from the patient database 124 and update patient data. The user module 110 allows healthcare professionals to manage marketing campaigns via the marketing automation module 116 and streamline the process of creating and customizing campaigns. The user module 110 enables practitioners to send messages using the messaging module 118. The user module 110 facilitates marketing content generation by executing the content generation module 120, providing content for marketing campaigns and messages. The user module 110 allows users to access and view analytics generated by the analytics module 122.

The display module 112 is a component of the healthcare marketing automation system 106, designed to present healthcare professionals with an organized and visually appealing interface for viewing and interacting with various data from the user database 114 and/or patient database 124. It achieves this by displaying the information in one or more dashboards, which allow the user to quickly view and/or modify information relating to patients, campaigns, messages, content, and other relevant aspects. The user database 114 is a component of the healthcare marketing automation system 106, responsible for storing and managing user data associated with healthcare practitioners. This data may include the practitioner's area of practice, location, phone number, whether they are accepting new patients, headshot or other photos, marketing campaign data, marketing content data, analytics data, and more. By maintaining this information, the user database 114 allows the system to personalize and manage marketing campaigns and communications, as well as provide valuable insights to the practitioners.

The marketing automation module is a component of the healthcare marketing automation system 106, designed to streamline and optimize the process of delivering marketing materials and communications to patients and prospective patients. This module determines which patients and/or prospective patients should receive marketing materials and communications by analyzing patient data and their healthcare journey stage. Based on this analysis, the module selects appropriate marketing materials and communications to be sent. To ensure the relevance and effectiveness of the marketing materials, the marketing automation module works in conjunction with the content generation module 120 to customize the content as needed. This allows for the creation of tailored messages that address the specific needs and concerns of patients and prospective patients. Once the marketing materials and communications are customized, the marketing automation module schedules the delivery at designated times, ensuring timely and well-coordinated communication. The messaging module 118 is then utilized to send the marketing materials and messages to the patients and prospective patients through their preferred communication channels.

The messaging module 118 is a component of the healthcare marketing automation system 106, responsible for delivering messages to patients and prospective patients through a variety of means. These means may include, for example, SMS, MMS, voice messages, and video messages. This versatility allows healthcare practitioners to communicate effectively with their patients using the most suitable and preferred channels. To further enhance the messaging experience, the messaging module 118 may provide customizable scripts that users can modify or adapt to suit their specific needs. These scripts can be used to create tailored, engaging, and informative messages that resonate with patients and prospective patients. In the case of voice and video messaging systems, the customizable scripts can be read aloud by the user, ensuring a personalized touch and human connection in the communications.

The content generation module 120 is a component of the healthcare marketing automation system 106, designed to facilitate the automated creation of customizable marketing and messaging content. This module allows healthcare practitioners to develop a diverse range of content types, which may include, for example, images, voice memos, videos, surveys, articles, scripts, templates, clinical studies, presentations, and documents. These content types can be used individually or in any combination to create engaging and informative materials that resonate with patients and prospective patients. The content generation module 120 also provides content suggestions, offering ideas and inspiration for content creation based on the user's practice area, patient demographics, and other relevant factors. This feature ensures that the generated content is both relevant and appealing to the target audience. Additionally, the module offers content creation tools, such as templates, design features, and graphics, which enable users to create professional-looking materials with ease.

The analytics module 122 is a component of the healthcare marketing automation system 106, designed to measure various aspects of the system in terms of patient and business metrics. This module provides valuable insights by evaluating key performance indicators, which may include, for example, engagement (clickthrough, view count, etc.), response rate (replies), conversion (scheduled appointments), retention (predicted vs. Actual milestone on healthcare journey), payments, referrals, content types, and campaigns. By analyzing these metrics, the analytics module 122 helps healthcare practitioners identify trends, measure the effectiveness of their marketing efforts, and optimize their strategies accordingly.

The patient database 124 is a component of the healthcare marketing automation system 106, designed to store and manage patient information. This database includes personally identifying information, such as patient name, birth date, contact information such as phone number, email, etc., and parent or guardian details, to facilitate personalized communications and tailored marketing messages. The patient database 124 also stores essential clinical data, including diagnosis, test results, and the patient's healthcare journey stage, providing healthcare practitioners with valuable insights to inform their marketing strategies and patient care plans. This comprehensive repository of patient data helps ensure that healthcare professionals can access and utilize the information they need to deliver targeted and effective marketing campaigns while maintaining a high standard of care for their patients. The patient module 126 is an integral part of the healthcare marketing automation system 106, designed to provide patients with a user-friendly interface for inputting and managing their data. The module features a funnel page that guides patients through the process of entering relevant information, ensuring that essential data is collected and stored in an organized manner. Patients can also view and manage their personal information, such as contact details, to keep their records up-to-date and accurate. Once the patient data is entered, the patient module 126 securely stores it in the patient database 124, making it readily accessible to healthcare practitioners for the purpose of delivering personalized marketing campaigns and tailored patient care.

The voice training module 128 is a component of the healthcare marketing automation system 106, designed to capture and analyze the unique vocal characteristics of healthcare professionals. It uses advanced algorithms to learn the nuances of their speech patterns, accents, and intonation. The voice training module 128 may enable the creation of highly realistic, AI-generated voiceovers for videos. It is crucial for ensuring that the AI-generated videos sound natural and authentically replicate the healthcare professional's own voice. The voice training module 128 may also include features for voice modification and adjustment, allowing healthcare professionals to fine-tune their AI-generated voice for clarity, tone, and emotional resonance appropriate to the content of the videos. For example, dr. Smith records several samples of his speech using the voice training module 128. This includes reading standard paragraphs, answering pre-set questions, and speaking naturally about various medical topics.

The face training module 130 is a component part of the healthcare marketing automation system 106, which focuses on learning and replicating the facial features and expressions of healthcare professionals. It employs deep learning techniques to accurately capture facial movements, expressions, and mannerisms. The face training module 130 is essential for creating lifelike and personalized video representations of the professionals. It ensures that the AI-generated videos not only sound like the healthcare providers but also visually resemble them in a convincing manner. Additional functionalities may include the ability to simulate different emotions or facial expressions to match the tone and context of the video content, enhancing the relatability and effectiveness of the communications. For example, DR. Smith participates in a face scanning session using the face training module 130. He is asked to express various emotions and make different facial expressions to capture a broad range of his facial movements.

The training database 132 is a component of the healthcare marketing automation system 106, which may be a comprehensive repository of data used to train the AI models in the system. It may include a wide range of voice samples, facial expressions, and other relevant data points collected from participating healthcare professionals. The training database 132 is crucial for the machine learning algorithms to learn and adapt to the specific characteristics of each professional. It ensures that the ai-generated content is personalized and accurate. The training database 132 may be continuously updated with new data to improve the system's accuracy and adaptability, ensuring that the ai models remain current with the professionals' evolving styles and mannerisms.

The transcript database 134 is a component of the healthcare marketing automation system 106, which may be a collection of text data that includes scripts, medical information, patient communication templates, and other relevant content. It serves as a resource for generating accurate and contextually appropriate video transcripts. The transcript database 134 may be instrumental in creating content that is not only medically accurate but also tailored to specific patient needs and healthcare scenarios. It may also include a variety of communication styles and templates, allowing for customization and diversity in the messaging, ensuring it resonates well with different patient demographics and healthcare situations. For example, dr. Smith accesses the transcript database to select a base script for a new patient education video. He chooses a template focused on diabetes management. He customizes the script, adding specific advice and recommendations based on his practice's approach to diabetes care.

The video generator module 136 is a component of the healthcare marketing automation system 106, which may be responsible for creating the final AI-generated videos. It integrates the outputs from the voice and face training modules to produce realistic and engaging video content. The video generator module 136 may utilize advanced graphics and rendering techniques to ensure that the videos are of high quality and appear seamless, with lifelike representations of the healthcare professionals. The video generator module 136 may allow professionals to generate videos quickly based on selected scripts, without the need for actual video recording sessions, saving time and resources. For example, dr. Smith uses the video generator module 136 to create a new patient education video. He uploads the customized script from the transcript database 134 and selects his digital avatar. The video generator module 136 combines Dr. Smith's AI-generated voice and digital avatar to create a video where the avatar speaks the script in his voice. For the purposes of the present technology, the video generator module 136 maybe, for example, a video generation technology stored on a local or cloud-based computing platform, may be a third party video generation provider, or some combination of in-house video generation and third party content generator.

The transcript generator module 138 is a component of the healthcare marketing automation system 106 which may be responsible for creating the textual content for the videos. It leverages natural language processing and AI to generate scripts that are coherent, informative, and tailored to the intended audience. The transcript generator module 138 may personalize content based on patient data, healthcare scenarios, and specific medical topics, ensuring that each video is relevant and engaging. It also allows for customization, enabling healthcare professionals to tweak or fully edit the generated scripts to better suit their style, tone, and the specific needs of their audience. For example, Dr. Smith decides to create a new video on hypertension management. He inputs key topics and patient-centric advice into the transcript generator module 138. The transcript generator module 138 generates a draft script, incorporating Dr. Smith's input with medically accurate information and an engaging narrative style. Dr. Smith reviews and customizes the script, adding personal anecdotes or specific advice, making it more tailored to his practice and patient base before using it in the video generator module 136.

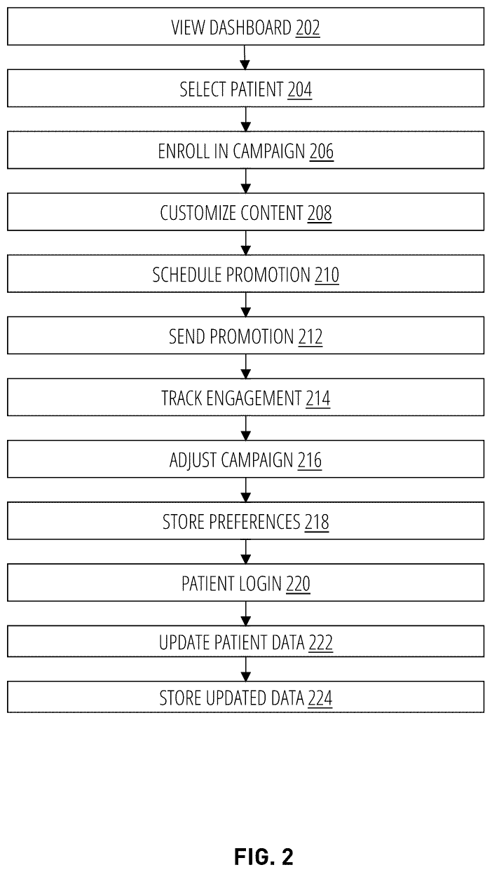

FIG. 2 illustrates an example method performed by a control module. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In some cases, a practitioner may log in to the healthcare marketing automation system 106 using their unique credentials, granting them access to the system's features and patient data. For example, Dr. Smith logs in to schedule a flu vaccination campaign for eligible patients in their practice. At step 202, upon logging in, the practitioner is presented with the dashboard, displaying an overview of patient data, marketing campaigns, messages, content, analytics, and other relevant information. For example, Dr. Smith sees that the most recent diabetes management campaign has a high engagement rate and several scheduled appointments.

At step 204, the practitioner selects a specific patient from the patient list or by searching patient database 124 to view, update, or manage their data and enroll them in a marketing campaign. For example, Dr. Smith selects a patient from the list, such as john doe, to review their healthcare journey and determine if they are eligible for any new campaigns, like the flu vaccination campaign. At step 206, the practitioner enrolls the selected patient in a marketing campaign by choosing from existing campaigns or creating a new one tailored to the patient's healthcare journey stage. For example, Dr. Smith enrolls John Doe in the flu vaccination campaign, as he is eligible and has not yet received the vaccine.

At step 208, the practitioner customizes the content of the marketing messages for the selected patient, utilizing the content generation module 120 to create engaging and informative materials. Dr. Smith customizes the content of the flu vaccination reminder message, adding a personal touch by mentioning John Doe's recent visit and the importance of the vaccine for his specific health conditions. At step 210, the practitioner schedules the delivery of the customized marketing message at a designated date and time, ensuring timely and relevant communication with the patient. For example, Dr. Smith schedules the flu vaccination reminder message to be sent to John Doe on the following Monday, as it is the optimal time to maximize engagement.

At step 212, the messaging module 118 sends the scheduled marketing message to the patient via their preferred communication channel, such as email, SMS, or voice message. For example, the messaging module 118 sends the customized flu vaccination reminder to John Doe via SMS, as indicated in his preferred communication channel. At step 214, the analytics module 122 tracks engagement metrics, such as clickthrough rates, view counts, responses, and conversions, to assess the effectiveness of the marketing campaign. For example, Dr. Smith monitors the engagement metrics of the flu vaccination campaign, noticing that many patients have clicked on the provided link and scheduled their vaccinations.

For example, at step 216, based on the analytics data, the practitioner adjusts the marketing campaign, tailoring the content, delivery, or other factors to optimize results and improve patient engagement. For example, based on the tracked engagement, Dr. Smith adjusts the campaign by changing the message content to emphasize the limited availability of flu vaccine appointments, motivating patients to schedule more promptly. At step 218, the user database 114 stores the practitioner's preferences, settings, and other relevant information, ensuring a personalized and efficient user experience. For example, the user database 114 stores Dr. Smith's preferences, such as message templates and preferred communication channels, for future use in the healthcare marketing automation system 106. At step 220, the patient logs in to the healthcare marketing automation system 106 through their patient device, accessing their patient data, and managing their healthcare information. For example, John Doc logs in to the patient portal of the healthcare marketing automation system 106 to review the flu vaccination reminder message and access his healthcare information.

At step 222, the patient updates their personal and clinical data, such as contact information, medical history, or appointment details, ensuring accurate and up-to-date information. For example, John Doe updates his contact information, including his phone number and email address, to ensure he receives future communications from Dr. Smith's practice. At step 224, the updated patient data is stored in patient database 124, allowing healthcare practitioners to access and manage the most recent information for better patient care and communication. For example, the healthcare marketing automation system 106 stores John Doe's updated contact information in the patient database 124, ensuring accurate communication for future campaigns and messages.

| | AREA OF | | |
|---|---|---|---|
| NAME | PRACTICE | CAMPAIGN NAME | CONTENT TITLE |
| DR. JANE SMITH | PEDIATRICS | ANNUAL CHECK-UPS | THE IMPORTANCE OF REGULAR |
| | | | CHECK-UPS |
| DR. JOHN DOE | CARDIOLOGY | HEART HEALTH MONTH | 5 TIPS FOR MAINTAINING A |
| | | | HEALTHY HEART |
| DR. SARAH | DERMATOLOGY | SKIN CANCER | PREVENTING SKIN CANCER: |
| BROWN | | | WHAT TO KNOW |

| | CLICKTHROUGH | APPOINTMENTS | PATIENT RETENTION |
|---|---|---|---|
| NAME | RATE | SCHEDULED | RATE |
| DR. JANE SMITH | 35% | 50 | 90% |
| DR. JOHN DOE | 25% | 30 | 85% |
| DR. SARAH | 40% | 45 | 80% |
| BROWN | | | |

An example user database 114 is provided above. The example user database 114 shows three rows of example data provided for user database 114, representing three different healthcare practitioners with their respective areas of practice, contact information, and details about their marketing campaigns. The table includes key performance metrics such as clickthrough rate, appointments scheduled, and patient retention rate for each campaign.

The user database 114 may be a repository for storing various types of user data associated with healthcare practitioners who utilize the healthcare marketing automation system 106. The stored user data may include, but is not limited to, the following types: personal information, professional information, profile data, marketing campaign data, marketing content data, and analytics data. Personal information may include data such as the practitioner's name, contact information, and login credentials (e.g., a unique username and password combination).

For example, Dr. Jane Smith's name, phone number, email address, and login credentials may be stored in the user database 114 for secure access to the system. Professional information may encompass data related to the practitioner's area of practice, location, phone number, and whether they are accepting new patients. For example, Dr. Smith's specialization in pediatrics, her practice's address, contact number, and her current patient acceptance status may be stored in the database. Profile data may include information such as the practitioner's headshot or other photos, biographical information, and credentials.

For example, a professional headshot of Dr. Smith, her educational background, and certifications may be stored in user database 114 to be displayed on her practice's website. Marketing campaign data may comprise information related to the practitioner's ongoing and past marketing campaigns, such as target audience, campaign duration, and promotional materials. For example, dr. Smith's recent campaign promoting annual check-ups for children, including the start and end dates, target age groups, and the promotional materials used, may be stored in user database 114. Marketing content data may include data related to the marketing content created or used by the practitioner, such as articles, images, videos, and templates.

For example, an article written by Dr. Smith on the importance of vaccinations and a series of educational videos she uses in her campaigns may be stored in user database 114. Analytics data may include information related to the performance metrics of the practitioner's marketing campaigns, such as engagement, response rates, conversion rates, and retention. For example, the clickthrough rate, the number of appointments scheduled, and the retention rate of patients who participated in Dr. Smith's annual check-up campaign may be stored in user database 114 for future analysis and campaign optimization.

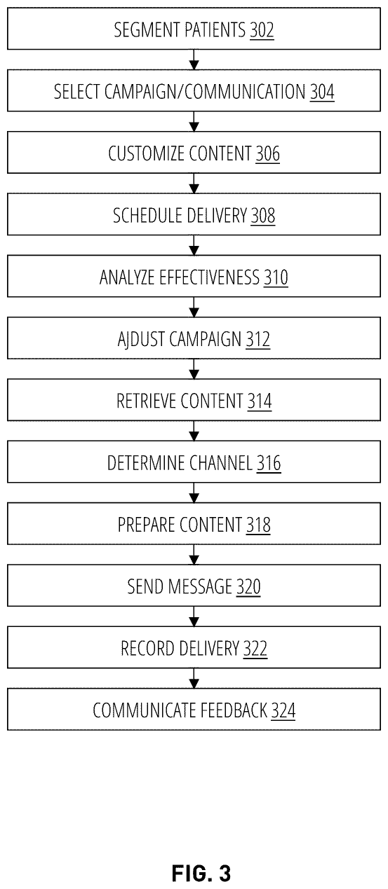

FIG. 3 illustrates an example method performed by a marketing automation module and a messaging module. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

In some cases, the marketing automation module 116 may retrieve patient data from the patient database 124, such as a patient's diagnosis, healthcare journey stage, and previous engagement history. For example, the marketing automation module 116 may identify patients who have recently been diagnosed with hypertension. In an exemplary embodiment of a healthcare journey for a myopia patient, the patient may initially experience difficulties with their vision, particularly in discerning distant objects.

This journey could encompass several stages, including the following:
Stage 1, identification of symptoms: the patient may recognize that their ability to focus on distant objects is compromised, which could be accompanied by eye strain, squinting, or headaches.
Stage 2, scheduling an appointment: the patient contacts their optometrist or ophthalmologist to schedule an appointment for a comprehensive eye examination.
Stage 3, diagnostic examination: during the appointment, the healthcare professional conducts a series of tests, such as visual acuity tests, retinoscopy, and refraction tests, to assess the patient's vision and identify the presence of myopia.
Stage 4, prescription determination: based on the examination results, the healthcare professional prescribes corrective lenses, such as eyeglasses or contact lenses, to address the patient's myopia and improve their visual acuity.
Stage 5, lens fitting and selection: the patient visits an optician to choose the appropriate frames and lenses or contact lenses that suit their individual needs and preferences.
Stage 6, follow-up appointments: the patient schedules regular follow-up appointments with their healthcare professional to monitor their myopia progression and ensure their corrective lenses remain effective in maintaining optimal visual acuity.
Stage 7, ongoing communication: throughout the healthcare journey, the patient may receive personalized communications from their healthcare provider, including educational materials, appointment reminders, and updates on the latest myopia treatments and management options. In some embodiments, a healthcare journey may be customized for a particular patient, condition, and/or practice.

At step 302, the marketing automation module 116 may segment patients into appropriate marketing groups based on their healthcare journey stage and other relevant factors. For example, patients with hypertension may be segmented into groups such as newly diagnosed, ongoing management, and high risk. In another example, myopia patients may be segmented into categories such as mild myopia, moderate myopia, and severe myopia, with each group receiving tailored marketing materials and communications addressing their specific needs and concerns. In a third example, the module may segment patients or marketing campaign recipients, such as parents or guardians, based on age, educational attainment, geography, or other demographic factors. This allows for the creation of tailored marketing materials for different age groups, such as children, young adults, adults, and the elderly, or for recipients in different locations, ensuring that the content is relevant and engaging for the target audience.

At step 304, the marketing automation module 116 may select an appropriate marketing campaign or communication for each patient group. For example, newly diagnosed patients may receive a campaign focusing on education and lifestyle changes, while high-risk patients may receive more targeted information on medication management and regular check-ups. In a second example, for a myopia patient group, the module may select a campaign that emphasizes the importance of regular eye examinations, preventive measures, and available treatment options, while for a group of patients with dry eye syndrome, the selected campaign might concentrate on environmental factors, proper eye care, and recommended products to alleviate symptoms.

At step 306, the module customizes the selected marketing materials or communications based on individual patient data using the content generation module 120. For example, the module may personalize a campaign for a high-risk hypertension patient by including their name, recent test results, and a reminder to schedule their next appointment. In a second example, for a patient with myopia, the module may customize a promotional email that addresses the patient by name, highlights their specific prescription details, and recommends personalized options for lenses or eyewear based on their lifestyle and preferences.

At step 308, the marketing automation module 116 schedules the delivery of the marketing materials or communications to the patients using the messaging module 118. For example, the module may send an educational email to newly diagnosed patients a week after their initial diagnosis, followed by a series of targeted messages over the next few months. In a second example, for a dermatology practice, the module may schedule a series of seasonal skincare tips, sending reminders to patients about sun protection during summer months or proper moisturizing techniques during winter months, ensuring that patients receive timely and relevant information.

At step 310, the module analyzes the effectiveness of the marketing campaign or communication using the analytics module 122, tracking metrics such as engagement, response rate, and conversion. For example, the module may determine that the educational email for newly diagnosed patients has a high open rate and leads to an increased number of scheduled appointments. In a second example, a physical therapy practice may launch a marketing campaign promoting a new exercise program for post-operative patients, and the analytics module 122 may track the number of patients who sign up for the program, the completion rate of the program, and the overall patient satisfaction to evaluate the campaign's success and identify areas for improvement. In another example, an optometrist my launch a marketing campaign to pediatricians who may have patients seeking care for eye conditions, such as myopia and dry eyes. The analytics module 122 may track the number of patients referred to the optometrist from various pediatricians who were targeted by the campaign.

At step 312, the marketing automation module 116 adjusts the marketing campaign or communication based on the analyzed data to optimize its effectiveness. For example, if the module determines that patients are more likely to open an email in the evening, it may adjust the sending time to increase engagement. In another example, the analytics module 122 determines that patients engage more with campaigns that incorporate video as compared with text or images; the system modifies, prioritizes, and/or suggests marketing materials with video content to further enhance patient engagement and response rates. In another example, the analytics module determines that pediatricians are most likely to open

At step 314, the messaging module 118 may retrieve the customized content and delivery information from the marketing automation module 116. For example, it may obtain a personalized email newsletter for a patient who has recently been diagnosed with diabetes. At step 416, the messaging module 118 determines the appropriate communication channel for each recipient based on their preferences and available contact information. For example, it may choose to send an SMS reminder to a patient with a registered mobile number, or an email to another patient with a registered email address. In some embodiments, the appropriate communication channel may be determined, at least in part, by analytics from analytics module 122, which may indicate which communication channel has the greatest chance of engagement. In other embodiments, the appropriate communication channel may be determined, at least in part, by the type of content in the message, e.g., voice message sent to voicemail of a patient's phone.

At step 318, the messaging module 118 prepares the content for the selected communication channel, adapting the format if necessary. For example, it may convert a video message into a suitable file format for sending via email or an mms. At step 320, the messaging module 118 sends the message to the patient through the chosen communication channel. For example, it may send an appointment reminder via email to a patient who has a scheduled follow-up visit in two weeks. At step 322, the messaging module 118 records the delivery status and any responses from the recipients. For example, it may track whether an email was opened, or whether a patient replied to an SMS appointment confirmation request. At step 324, the messaging module 118 communicates the delivery and response information back to the analytics module 122 for further analysis. For example, it may provide data on how many patients opened a particular email newsletter or responded to an appointment reminder.

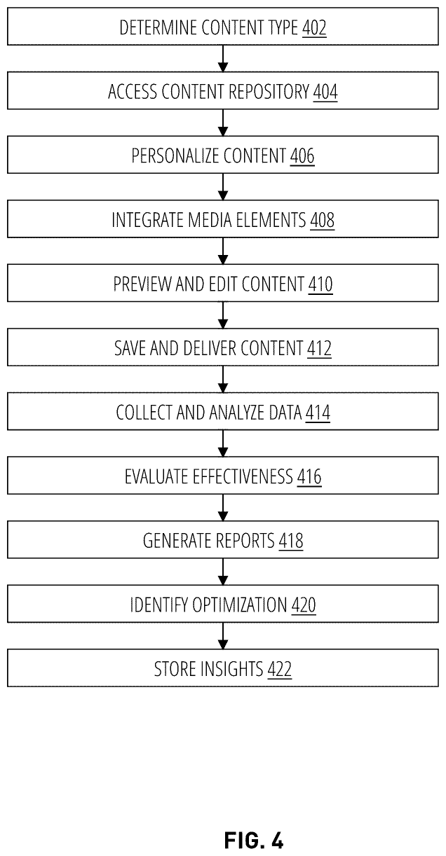

FIG. 4 illustrates an example method performed by a content generation module and an analytics module. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The content generation module 120 may receive input from the user, such as a desired type of content or a specific marketing message to be generated. For example, a healthcare practitioner may request an educational video on dental hygiene for a specific patient group. In a second example, a dermatologist may request the generation of an infographic explaining the different types of skin conditions, their causes, and appropriate treatments, targeting patients who have recently been diagnosed with a specific skin condition.

At step 402, the module identifies available content templates, resources, and tools based on the user input. For example, the module may provide a list of video templates that can be used to create an educational video on dental hygiene. In some embodiments, the content generation module 120 may identify created content that matches the user request, such as customizable content that includes a set of reusable resources that can be customized with patient data and/or practitioner data. For example, an instructional video for applying myopia treatments, such as ortho-k, may be customized to a title screen that contains the practitioner's name and practice logo, and the text and audio overlay for the video may be selected based on the patient's age, e.g., one set of audio for 5 to 10 year old, another set for 11 to 16 years, and a third set for 17 and over, such that the content is age appropriate for the content audience.

In a second example, the content generation module 120 may identify a collection of infographic templates and images related to skin conditions, which can be customized to create an informative visual aid for a dermatologist's patients. The customization options may include adding the practitioner's name, practice logo, and selecting appropriate text and visuals based on the target audience's demographics, such as age or geographic location, to ensure the content is relevant and engaging for the intended recipients. In a third example, the content generation module 120 may identify a set of email templates for physical therapy practices, focusing on exercise routines and pain management techniques for specific patient groups. The customization options may include incorporating the patient's name, relevant clinical data, and tailoring the exercise recommendations based on the patient's current progress and physical condition. Additionally, the content may be adjusted to account for cultural factors, language preferences, or accessibility requirements, ensuring that the marketing materials are both informative and engaging for the target audience.

At step 404, the content generation module 120 may access a content repository and provide content suggestions or customization options based on the user's preferences, the patient data, and the identified content templates, resources, and tools. For example, the module may offer different video styles, background music options, and on-screen text templates for the dental hygiene video. In one example, the content generation module 120 may suggest content for a parent of a child with myopia who has not yet scheduled a treatment consultation that emphasizes the importance of treating myopia early after diagnosis in order to prevent progression of the disorder and additional symptoms. In a second example, the content generation module 120 may suggest content for a dermatology practice, targeting patients with acne-prone skin who haven't attended a follow-up appointment. The content could emphasize the importance of consistent treatment and regular check-ups to monitor progress and adjust the treatment plan as needed. The module may offer various visual styles, treatment success stories, and interactive elements, such as quizzes or polls, to engage the patients and encourage them to schedule their next appointment.

At step 406, the user personalizes and customizes the content as needed using the provided suggestions and options. For example, the healthcare practitioner may choose a specific video style, background music, and on-screen text for the dental hygiene video. In another embodiment, the content may be customized to include an excerpt and a reference to a clinical study which is relevant to a video's content. In a second example, a physical therapist creating a video on exercises for lower back pain may customize the content to include animations demonstrating proper technique, as well as an excerpt and a reference to a clinical study supporting the effectiveness of the exercises. The physical therapist can also tailor the content to mention any relevant patient data, such as common issues faced by patients with specific conditions, and may provide additional resources, like printable exercise guides or links to informative articles on the topic.

At step 408, the content generation module 120 generates the customized content based on the user's selections. For example, the module may create the final dental hygiene video, incorporating the chosen video style, background music, and on-screen text. In a second example, the module may produce an infographic for a dermatologist that visually demonstrates the benefits of sun protection, incorporating patient demographics, such as age and skin type, and highlighting specific sun protection products recommended by the dermatologist. In a third example, the module could generate a personalized email campaign for a mental health and addiction treatment center, including tailored content addressing the specific needs and concerns of each patient, relevant resources, and success stories from other patients who have undergone similar treatment programs.

At step 412, the generated content is saved and stored for later use or immediate delivery via the messaging module 118. For example, the dental hygiene video may be saved in a specific marketing campaign folder and made available for delivery to the targeted patient group. The content generation module 120 may provide content customization options and suggestions for any of a number of private healthcare practices. In one example, a myopia clinic can utilize the content generation module 120 to create personalized educational content, such as videos, articles, and presentations, addressing myopia prevention and management. By accessing patient data, such as the patient's age, degree of myopia, and treatment history, the module can generate content that is highly relevant and tailored to each patient's needs. For instance, the module could create an informative article discussing the importance of regular eye exams, tips for reducing eye strain, and the latest advancements in myopia treatment options, such as orthokeratology or special contact lenses. The content can also consider the patient's engagement data and communication preferences to ensure the information is delivered in the most effective and engaging manner. In another example, the content generation module 120 can create a series of images and articles for a dry eye's clinic, incorporating patient data such as age, gender, and severity of the condition. The module could generate personalized articles discussing the causes of dry eyes, preventive measures, and treatment options available at the clinic. The articles could also include images tailored to the patient's age and gender, ensuring the content is relatable and engaging.

The content may also be created based on the patient's communication preferences and engagement data, ensuring the information is delivered through the preferred channels and is more likely to be read and acted upon. In another example, a dermatology clinic could use the content generation module 120 to create videos and presentations that address various skin conditions and their treatments. The module could access patient data, such as personal information, clinical data, and appointment history, to customize the content for each patient. For example, if a patient has a history of acne treatments, the module could generate a video discussing acne prevention and new treatment options available at the clinic. The content could also consider the patient's engagement data, allowing the clinic to tailor the video's length, format, and style to maximize patient engagement. In another example, content generation module 120 can assist a physical therapy center in creating a series of voice memos, videos, and text documents with exercise instructions and recommendations for patients based on their specific conditions, injuries, or recovery goals. By incorporating patient data, such as age, injury type, and progress, the module can generate content that is highly relevant and personalized.

The content can also consider communication preferences and engagement data to ensure the most effective delivery method for each patient. A nursing home can utilize the content generation module 120 to create personalized newsletters, surveys, and clinical studies for residents and their families. The module can access patient data such as age, medical conditions, and personal interests to generate content that is both informative and engaging. For example, a newsletter could include articles on managing chronic conditions, upcoming events at the nursing home, and success stories of residents who have achieved specific health milestones. In another example, content generation module 120 can generate a range of content for a mental health and addiction treatment center, such as articles, scripts, and presentations on various mental health conditions and addiction recovery strategies. By incorporating patient data, such as diagnosis, treatment history, and engagement data, the module can generate content that is highly relevant and personalized to each patient. In another example, the content generation module 120 can generate a range of content for a mental health and addiction treatment center, such as articles, scripts, and presentations on various mental health conditions and addiction recovery strategies. By incorporating patient data, such as diagnosis, treatment history, and engagement data, the module can generate content that is highly relevant and personalized to each patient. The content can also consider communication preferences to ensure the most effective delivery method for each patient.

At step 412, the content generation module 120 finalizes the personalized content created in the previous steps and prepares it for delivery. The content may be sent directly to the messaging module 118 for immediate distribution or stored within the healthcare marketing automation system 106 for later use. For example, a myopia doctor may schedule a series of informative articles on myopia prevention and management to be sent to their patients at specific intervals, and the content generation module 120 saves these articles and delivers them to the messaging module 118 at the designated times. In a second example, a physical therapy practice may create a series of exercise demonstration videos tailored to individual patients' rehabilitation plans, and the content generation module 120 stores these videos within the system, allowing the practitioner to access and send them to patients as needed during their recovery process.

In some cases, the analytics module 122 collects data related to patient interactions, marketing campaigns, and messaging within the healthcare marketing automation system 106. For example, the module gathers information on message open rates, click-through rates, and patient responses for a myopia doctor's email campaign. In a second example, the module also collects business data such as scheduled appointments, attended appointments, practitioner utilization, payments, and patient satisfaction ratings to provide a comprehensive analysis of the practice's performance and marketing effectiveness, enabling the practitioner to make informed decisions about their marketing strategies and overall business operations.

At step 414, the analytics module 122 processes and analyzes the collected data to generate valuable insights and metrics. For example, it calculates the average response rate for a myopia doctor's email campaign and identifies which types of content have the highest engagement. In a second example, the module may analyze the correlation between specific marketing campaigns and subsequent appointment bookings or attendance rates, allowing the myopia doctor to determine which marketing strategies are most effective in driving patient engagement and clinic visits, and adjust their marketing efforts accordingly.

At step 416, the analytics module 122 compares the generated metrics to predefined goals or benchmarks to evaluate the effectiveness of marketing campaigns and messages. For example, it compares the myopia doctor's email campaign response rate to industry averages or the doctor's previous campaigns. In a second example, the module may compare the number of scheduled appointments, attended appointments, practitioner utilization, and payments for a specific marketing campaign to established targets, allowing the myopia doctor to assess the campaign's impact on overall practice performance and make data-driven decisions for future marketing strategies.

At step 418, the analytics module 122 generates reports and visualizations to present the analyzed data and insights to healthcare practitioners. For example, it creates a dashboard displaying the response rate, engagement, and conversion metrics for the myopia doctor's email campaign. In a second example, the module generates a comprehensive report that includes visualizations such as bar graphs and pie charts, depicting the scheduled appointments, attended appointments, practitioner utilization, and payments in relation to the specific marketing campaign. This enables the myopia doctor to quickly assess the effectiveness of the campaign and identify areas for improvement or modification.

At step 420, the analytics module 122 identifies opportunities for optimization and improvement in marketing campaigns, messaging, and content based on the analyzed data. For example, it may suggest that the myopia practitioner adjust the frequency or timing of their email campaign to improve patient engagement. In a second example, the module may identify that the inclusion of personalized appointment reminders and payment options in the marketing campaign led to a significant increase in attended appointments and prompt payments. Consequently, the module may recommend further incorporating these elements into future campaigns to enhance overall effectiveness and efficiency in the myopia practice.

At step 422, the analytics module 122 stores the analyzed data and generated insights within the healthcare marketing automation system 106 for future reference and use. For example, it saves the myopia doctor's email campaign data, allowing the practitioner to review and compare the performance of future campaigns. In another example, a dry eye clinic, the analytics module 122 analyzes the performance of a marketing campaign featuring educational articles and videos about dry eye syndrome. The module considers patient demographics, clinical data, communication preferences, and engagement with the content. After analysis, the module identifies that patients with moderate dry eye symptoms are more likely to schedule appointments after viewing videos rather than reading articles. The healthcare practice adjusts its marketing strategy accordingly to improve patient outreach. In another example, a dermatology practice, the analytics module 122 evaluates a marketing campaign that uses surveys and interactive quizzes to educate patients about various skin conditions.

By considering factors such as patient age, clinical data, and engagement with the content, the module discovers that younger patients prefer taking quizzes, while older patients are more likely to respond to surveys. The dermatology practice can then tailor its marketing content to target different age groups more effectively. In another example, physical therapy clinic, the analytics module 122 examines a marketing campaign utilizing testimonials, before-and-after images, and exercise demonstration videos. The module considers factors like patient diagnosis, treatment progress, and engagement data. The analysis reveals that patients with sports-related injuries are more likely to schedule appointments after viewing exercise demonstration videos, while patients with age-related mobility issues respond better to testimonials. The physical therapy clinic can then adjust its marketing materials to better target specific patient groups. In another example, a nursing home, the analytics module 122 assesses the effectiveness of a marketing campaign featuring facility tours, resident testimonials, and staff presentations.

The module considers personal data, communication preferences, and engagement data. The analysis uncovers that potential residents and their families are more likely to schedule visits after viewing staff presentations, while current residents and their families appreciate testimonials from fellow residents. The nursing home can use these insights to optimize its marketing strategy and attract new residents. In another example, a mental health and addiction treatment center, the analytics module 122 analyzes a marketing campaign that shares success stories, therapy session templates, and clinical studies. The module evaluates factors such as patient diagnosis, treatment progress, and engagement with the content. The analysis shows that patients in early recovery stages respond positively to success stories, while patients in later recovery stages find clinical studies more valuable. The treatment center can then adjust its marketing approach to provide more relevant content for patients at different stages of their recovery journey. In another example, a birth center, the analytics module 122 evaluates a marketing campaign that utilizes prenatal class schedules, educational articles, and videos about the birthing process.

The module considers factors such as patient demographics, clinical data, and communication preferences. The analysis reveals that first-time mothers are more likely to enroll in prenatal classes after viewing videos about the birthing process, while experienced mothers prefer reading educational articles. The birth center can then optimize its marketing strategy to cater to the unique needs of different patient groups.

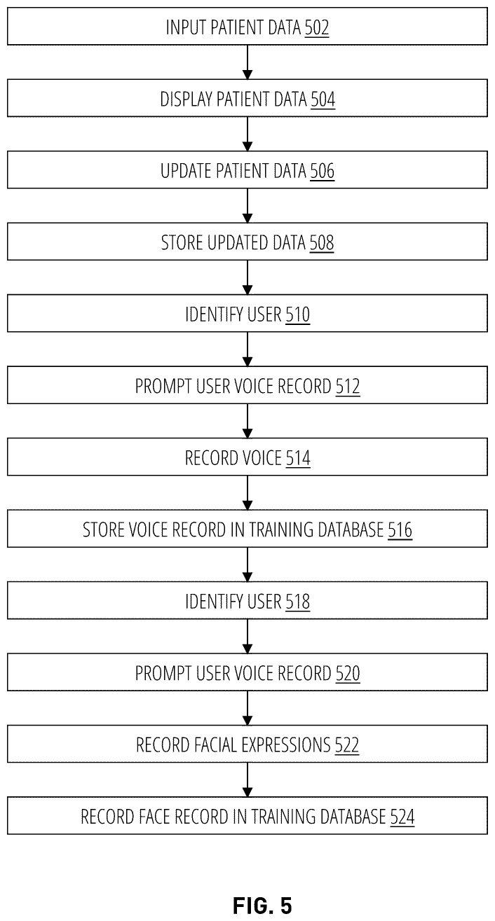

FIG. 5 illustrates an example method performed by a patient module, a voice training module and a face training module. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

A patient database 124 may store various types of patient data, which may include, but are not limited to, personal identifying information, clinical data, communication preferences, appointment/attendance data, previously received communications, and engagement data. For example, patient database 124 may store personal identifying information such as a patient's name, date of birth, address, contact information, and insurance details. In one example, the database may store data for john doe, a 35-year-old patient with the contact number 555-1234, residing at 123 Main St, Anytown, USA, and covered by XYZ insurance company.

Additionally, patient database 124 may store clinical data, including diagnoses, test results, prescribed medications, and treatment plans. For instance, the database may store data for a patient diagnosed with type 2 diabetes, with a recent hbalc test result of 7.5%, prescribed metformin, and following a treatment plan that includes regular blood glucose monitoring and dietary changes. Patient database 124 may also store communication preferences for patients, indicating their preferred channels and frequency of communication. As an example, a patient may prefer to receive appointment reminders via email rather than phone calls, and educational material about their condition on a monthly basis.

In some embodiments, patient database 124 may store social media information about the patient and communicate with the patient via advertisements or direct messages over social media. In other embodiments, patient database 124 may show the patient prefers printouts of communications and send communications via physical mail and/or in-office printed handouts. In other embodiments, patient database 124 may associate multiple communication channels with a single user and provide information, messaging, content, and reminders via a variety of communication channels. Appointment and attendance data stored in patient database 124 may include information about past, present, and future appointments, along with records of attendance or cancellations.

For example, the database may store information about a patient who attended a dermatology appointment on Feb. 1, 2023, and has a follow-up appointment scheduled for Mar. 15, 2023. Previously received communications data stored in patient database 124 may comprise a record of the marketing and informational materials sent to a patient, along with any personalized content or messages. For example, the database may store information about an email sent to a patient on Jan. 15, 2023, containing an article about managing chronic pain, along with a personalized message from their healthcare provider.

Patient database 124 may store engagement data, which could include metrics such as click-through rates, views, responses, and other interactions with marketing materials and communications. For example, the database may store data indicating that a patient viewed a video about sleep apnea on the healthcare provider's website and clicked on a link to schedule a consultation. The patient database may store read receipts for text and/or email messages, showing data indicating whether or not the patient received and read a message. Patient database 124 facilitates the organization, retrieval, and analysis of patient data, enabling healthcare providers to deliver personalized care and targeted marketing communications.

In some cases, the patient module 126 enables patients to access the healthcare marketing automation system 106 through a secure, user-friendly interface. For example, a patient may log in to the system using their unique credentials, such as an email address and password, on a dedicated patient portal. In some embodiments, the patient module 126 may allow the patient to input their preferred communication channel (email, text message, phone call, etc.) In some embodiments, the patient module 126 enables the patient to authorize a device to access their data, designate another party, such as parent, guardian, or spouse who may be allowed to access their patient data.

At step 502, the patient module 126 may present a funnel page or questionnaire, allowing patients to input their personal and clinical data. For example, a new patient may provide their name, date of birth, contact information, medical history, and insurance details. At step 504, the patient module 126 may retrieve and display relevant patient data from the patient database 124. For example, a patient may view their appointment history, treatment plan, and test results after logging into the system. In some cases, at step 506, the patient module 126 allows patients to update and manage their personal and clinical data. For example, a patient may update their contact information, add a new insurance provider, or report a change in their medical condition. In some cases, the patient module 126, at step 508, securely stores any updated patient data in patient database 124. For example, if a patient updates their phone number, the system saves the new contact information to patient database 124 for future reference and communication.

In some cases, the voice training module 128 may identify the user of the system at step 510. For example, Dr. Smith logs into the healthcare marketing automation system using his unique credentials. This may include entering a username and password or using biometric authentication, depending on the system's security protocol. The system recognizes Dr. Smith and loads his profile. This action ensures that the voice data collected is accurately associated with dr. Smith's account in the system. At step 512, the voice training module 128 may provide a prompt for the user to record. This prompt may include a series of scripted paragraphs, questions, and topics to read aloud. These scripts are designed to capture a wide range of vocal characteristics, including different speech patterns, tones, and emotional expressions. For example, the voice training module 128 prompts dr. Smith to use a high-quality microphone and a quiet environment for clear voice capture and gives him text to read aloud. It might also suggest proper positioning and speaking volume for optimal recording quality.

At step 514, the voice training module 128 may record the user's voice. The voice training module 128 may provide real-time feedback on the quality of the recording, such as volume levels or background noise detection, and might suggest adjustments to ensure the best quality recording. For example, dr. Smith begins recording his voice by following the on-screen prompts. As he speaks, the voice training module 128 captures the audio in real-time. Dr. Smith continues to read the provided material until the module indicates that sufficient voice data has been captured. He can pause and resume recording as needed and may also have the option to re-record sections if necessary. At step 516, the voice training module 128 may process the audio data and store it in the training database 132. For example, the system tags and categorizes dr. Smith's voice data with his profile, ensuring it is readily available for training the ai voice model. The stored data may then be used by advanced algorithms to analyze and learn from dr. Smith's vocal characteristics. This process involves extracting features like pitch, tone, accent, and speech patterns to create a personalized AI voice model that replicates Dr. Smith's voice.

In some cases, the face training module 130 may identify the user of the system in step 518. For example, Dr. Smith logs into the healthcare marketing automation system using his unique credentials. This may include entering a username and password or using biometric authentication, depending on the system's security protocol. The system recognizes dr. Smith and loads his profile. This action ensures that the face data collected is accurately associated with dr. Smith's account in the system. At step 520, the face training module 130 may provide a prompt of facial expressions and/or lines of dialogue. For example, the face training module 130 provides dr. Smith with on-screen instructions for the facial expression recording process. These instructions guide him on how to position himself in front of the camera, proper lighting conditions, and other setup recommendations for optimal recording quality. Dr. Smith is advised to maintain a neutral facial expression to start with, before moving on to a series of guided expressions. The module may prompt him to display various emotions such as happiness, sadness, surprise, and others to capture a wide range of facial movements.

At step 522, the face training module 130 may record the user's facial expressions. The face training module 130 may offer real-time feedback on the recording quality, such as advising the user to adjust their position, change lighting, or repeat an expression for clearer capture. For example, dr. Smith starts the recording session. As he changes his expressions according to the prompts, the face training module 130 captures high-resolution video footage, focusing on his facial movements and expressions. Dr. Smith continues following the prompts until the required expressions are recorded. The face training module 130 ensures a diverse range of expressions is captured, including subtle nuances and different intensity levels of each emotion.

At step 524, the face training module 130 may processes the facial expression data and securely stores it in the training database 132. Each piece of facial data may be tagged and linked to the user, making it easily accessible for creating and refining their digital facial model. The stored data is then utilized by advanced machine learning algorithms to analyze the user's facial characteristics. This involves mapping out facial landmarks, understanding muscle movements, and learning the unique aspects of his expressions. This data is essential for creating a realistic and personalized digital representation of dr. Smith for use in AI-generated videos.

The transcript database 134 may contain text data that includes scripts, medical information, patient communication templates, and other relevant content. It serves as a resource for generating accurate and contextually appropriate video transcripts. The transcript database 134 may be instrumental in creating content that is not only medically accurate but also tailored to specific patient needs and healthcare scenarios. It may also include a variety of communication styles and templates, allowing for customization and diversity in the messaging, ensuring it resonates well with different patient demographics and healthcare situations.

For example, Dr. Smith accesses the transcript database to select a base script for a new patient education video. He chooses a template focused on diabetes management. He customizes the script, adding specific advice and recommendations based on his practice's approach to diabetes care. Each entry, may be identified by a “record ID,” is categorized under specific healthcare-related topics, which are further divided into subcategories. The titles succinctly describe the content of the transcripts. In the “content” column, may be a script or dialogue tailored for a particular healthcare subject, designed to read naturally as if spoken by a healthcare professional to a patient. For example, the dialogue under “understanding myopia” explains the condition in simple terms suitable for teens and young adults. The content is crafted to facilitate clear communication of medical concepts to patients, enhancing their understanding and engagement with their health management. Each script may be marked with a “last updated” date, indicating the most recent revision to ensure the information is current and accurate. The “target demographic” column specifies the intended audience for each script, allowing healthcare professionals to select the most appropriate content for their patients based on age, health condition, or other relevant factors.

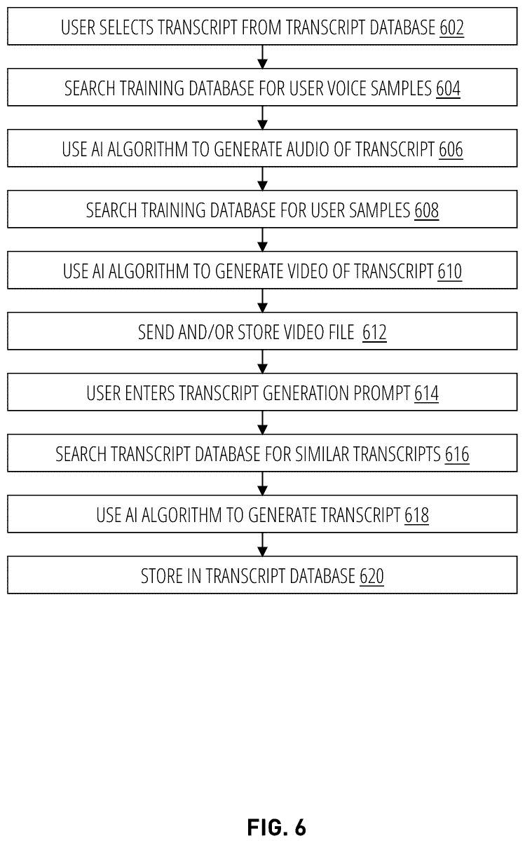

FIG. 6 illustrates an example method performed by a patient module, a voice training module and a face training module. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The video generator module 136 may allow the user to select a transcript from the transcript database 134 in step 602. For example, Dr. Smith accesses the transcript database 134 and browses through the available content categories. He selects a transcript that best suits his needs, such as a script on “understanding myopia” tailored for a teenage audience. The selected transcript is then loaded into the video generator module 136 as the base content for the video. The user may also be able to write a transcript from scratch at this step. Some transcripts may have customizable values such as the current date, name of the medical professional, name of the patient etc.

At step 604, the video generator module 136 may search the training database 132 for voice samples of the user, or another medical professional. For example, the search returns samples of dr. Smith's voice that have been previously recorded and stored, ensuring the AI has the necessary data to replicate his speech accurately. At step 606, the video generator module 136 may use text-to-speech (TTS) technology to generate audio of the transcript, mimicking the healthcare professional's voice, intonation, and speaking style. Once the audio is generated, it may be synchronized with the intended pacing and emphasis of the script, creating a natural-sounding voiceover.

Text-to-speech (TTS) technology within the video generator module 136 may be a sophisticated example of speech synthesis that transforms written text into spoken words, aiming to produce a voiceover that is nearly indistinguishable from a live human voice. When Dr. Smith, or any healthcare professional, inputs a script into the system, the TTS engine may first prepare the text by cleansing it of any irrelevant characters or formatting issues. The text may then be subjected to an in-depth analysis using natural language processing algorithms, which discern the grammatical structure, contextual meaning of words, and the emotional undertone to predict how the text should be naturally spoken. Following this analysis, the system may convert the processed text into a series of phonemes, the basic vocal gestures of the language, utilizing a comprehensive phonetic database tailored to the specific language of the input.

The AI may then infuse these phonemes with the appropriate prosodic elements—the rhythm, stress, and intonation that characterize natural speech patterns. It is at this stage that the ai's capabilities shine, as it assigns the correct emphasis to words and crafts the pitch and cadence that one would expect in a conversational setting. The voice synthesis process may use a voice model previously trained with recordings of the healthcare professional's voice, ensuring that the output mirrors their unique vocal characteristics. The tts ai may perform quality checks and refinements to ensure that the speech sounds authentic. It may fine-tune intonations, adjust the pacing, and insert natural breaths and pause to enhance the realism of the voiceover. The advanced TTS algorithms within the video generator module 136 make it possible to manage complex medical terminologies and sentence structures with ease, producing clear, professional, and engaging audio that complements the visual elements of the AI-generated videos. Through continuous learning from feedback and improvements, the AI algorithm may be improved and fine-tuned.

At step 608, the video generator module 136 may search the training database 132 for face samples of the user, or another healthcare professional. For example, the search returns samples of dr. Smith's facial expressions that have been previously recorded and stored, ensuring the AI has the necessary data to replicate his facial mannerisms accurately. At step 610, the video generator module 136 may use advanced AI rendering techniques to create and combine an animated avatar with the audio voiceover, creating a cohesive and engaging video. The ai algorithm may optimize lip-syncing, expressions, and head movements to correlate with the spoken content, enhancing the realism of the video.

For example, the video generator module 136 utilizes the gathered face samples to animate Dr. Smith's digital avatar, ensuring the facial movements are coordinated with the generated audio. Once Dr. Smith selects his digital avatar and the AI-generated voiceover is ready, the rendering AI uses the facial samples previously stored in the training database 132 to craft an avatar that not only resembles dr. Smith visually but also mimics his expressions and nuances in fine detail. The AI algorithm may be adept at synchronizing the avatar's lip movements with the audio to achieve precise lip-syncing, a cornerstone of creating believable digital human interactions. This synchronization is vital, as even a minor mismatch between the audio and visual elements can disrupt the viewer's sense of immersion. The AI may carefully adjust the avatar's expressions and head movements to ensure they align naturally with the inflections and rhythm of the spoken words. This attention to detail means that when the avatar speaks, the eyebrows, eyelids, and other facial features respond as they would in a real person, conveying emotions that resonate with the message being delivered. This may involve the use of generative adversarial networks (GANs), which involve two neural networks contesting with each other to create and refine realistic outputs.

In the context of video rendering for applications like the video generator module 136, these networks are trained on extensive datasets that include various angles, lighting conditions, and facial expressions to generate photorealistic facial animations that can be synchronized with audio. The video generator module 136 may construct a digital skeleton that maps the facial features and movements. This skeleton is then overlaid with a texture mesh that represents the skin and features of the healthcare professional. Advanced ai algorithms manipulate this mesh to match the facial expressions and lip movements needed for the script. This is achieved through the analysis of the phonemes and emotions conveyed in the voiceover, ensuring that the avatar not only says the words but also expresses them with the appropriate facial cues. The rendering process may also involve sophisticated shading and lighting techniques that allow the avatar to blend seamlessly into various environments, creating a natural look regardless of the setting. This is particularly important in healthcare communications, where trust and clarity are paramount. The avatar must not only look like the professional but also exhibit a level of realism that engenders confidence in the viewer. At step 612, the video generator module 136 may send the video directly to the intended recipients, such as patients or colleagues, via the messaging module 118, and/or store the video in a database such as the user database 114. The user may preview the video to ensure it meets expectations and make any necessary adjustments. For the purposes of the present technology, the video generator module 136 maybe, for example, a video generation technology stored on a local or cloud-based computing platform, may be a third party video generation provider, or some combination of in-house video generation and third party content generator.

At step 614, the transcript generator module 138 may allow the user to enter a transcript generation prompt. This may be a text based request used to prompt an 11m, such as gpt-4, to generate a longer transcript. For example, dr. Smith enters specific prompts or keywords related to hypertension management, including topics like blood pressure monitoring, lifestyle changes, medication adherence, and patient-centric advice that he wants to highlight in a video. Dr. Smith may also input demographic information about his intended audience, such as age range, to ensure the content's relevancy. At step 616, the transcript generator module 138 may scan the transcript database 134 for existing scripts and materials that match the entered prompts and topics. The transcript generator module 138 may use natural language processing to understand the context and nuances of the prompt provided, allowing it to retrieve the most relevant and related transcripts as a reference for generating the new content. For example, if the prompt reads “informative video on myopia targeted to esl immigrants” then existing transcripts on myopia and/or transcripts targeted to esl immigrants may be used as reference. These reference transcripts may be specific to the user in order to capture that user's manner of speaking.

At step 618, the transcript generator module 138 may draft a transcript that is informative, tailored to the audience, and stylistically aligned with a user's previous content, ensuring consistency in tone and approach. Natural language processing (NLP) may be used to interpret the keywords and topics, understanding not only the literal meaning but also the intent behind the prompt. The transcript generator module 138 may reference the user's previous inputs and content to grasp the style and tone that should be reflected in the new transcript. An AI algorithm may then construct the script by selecting relevant information from a vast repository of medical knowledge and existing transcripts within the transcript database 134.

Machine learning algorithms enable the AI to curate this information, organizing it in a logical and coherent sequence that effectively communicates the intended message. The AI may cross-reference the latest clinical guidelines and research data. It may also use medical ontologies, which provide structured medical knowledge, to maintain accuracy and relevance. The ai may comprise language models trained on a wide range of healthcare communication examples, including the user's previous scripts, to match the writing style and tone to the user's typical content. The algorithms may be capable of learning nuances such as sentence length preference, use of jargon versus layperson terms, and even the rhythm of the prose, ensuring that the new transcript feels familiar to the audience. At step 620, the transcript generator module 138 may store the generated transcript in the transcript database 134. The script may be tagged with relevant metadata, such as the creation date, topics covered, intended audience demographics, and any specific notes or customizations made by the user. The user may be able to review, edit, and further personalize the script before finalizing it for use in the video generator module 136, where it may be transformed into a patient education video complete with his digital avatar and voiceover.

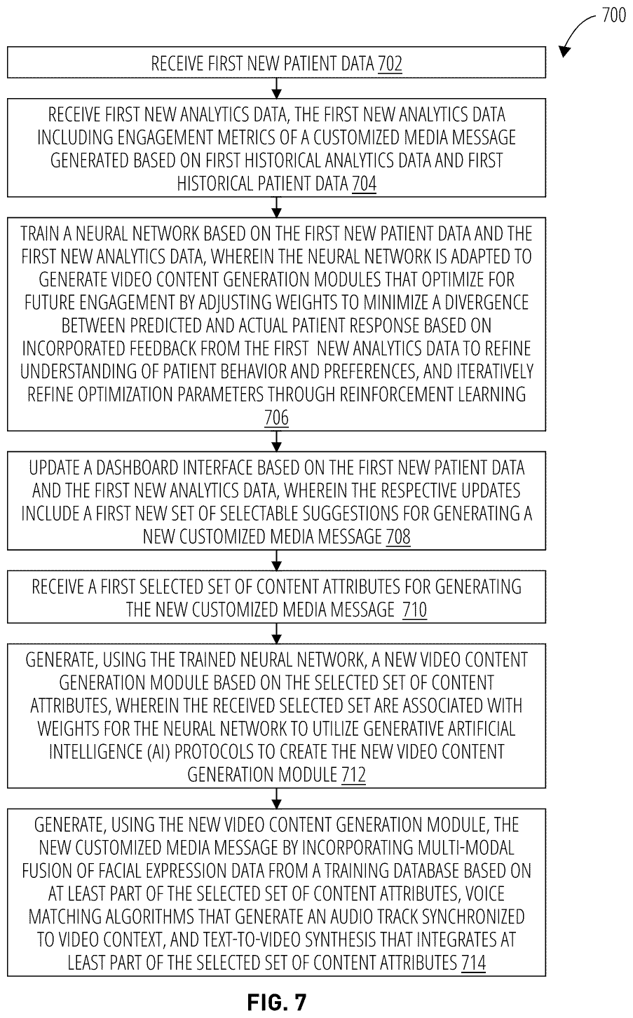

FIG. 7 illustrates an example method 700 for generating a customized media message. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

According to some examples, the method includes receiving first new patient data at step 702. The new patient data may include medical history, current medications, clinical data, lab results, diagnostic imaging, procedure and treatment records, clinical notes, and lifestyle and social determinants.

According to some examples, the method includes receiving first new analytics data, the first new analytics data including engagement metrics of a customized media message generated based on first historical analytics data and first historical patient data at step 704. The first new analytics data may include click-through rate (CTR), conversion rate, bounce rate, time on media, social media engagement (likes, shares, comments), video view count, video completion rate, and overall engagement rate.

According to some examples, the method includes training a neural network based on the first new patient data and the first new analytics data at step 706. In some cases, the neural network is adapted to generate video content generation modules that optimize for future engagement by adjusting weights to minimize a divergence between predicted and actual patient response based on incorporated feedback from the first new analytics data to refine understanding of patient behavior and preferences, and iteratively refine optimization parameters through reinforcement learning

As the neural network continues to learn from subsequent patient data and analytics insights, the neural network may refine its video content generation modules by incorporating feedback loops that adapt weights in real-time, enabling the system to better anticipate and respond to evolving patient preferences. Through iterative refinement of optimization parameters via reinforcement learning at step 706, the neural network may further adjust its approach to minimize divergence between predicted and actual patient engagement, thereby optimizing the overall quality and effectiveness of video content generation.

According to some examples, the method includes updating a dashboard interface based on the first new patient data and the first new analytics data at step 708. In some cases, the respective updates include a first new set of selectable suggestions for generating a new customized media message. As an example, the updated dashboard interface may include a new “myopia treatment tone” selector, which allows clinicians to choose from tone options such as: “supportive”, “educational”, and “motivational”, each accompanied by example phrases such as “empowering patients for better vision care” or “stay on top of your myopia treatment plan”. The updated dashboard interface may also introduce a new “tone tuning” feature, which enables clinicians to adjust the tone's pitch and volume using a slider, allowing for more nuanced control over the messaging experience. As another example, the updated dashboard interface may include “content theme” dropdown menu, offering options such as: “myopia awareness”, “treatment success stories”, or “lifestyle tips”, each paired with sample image thumbnails that showcase relevant visuals such as eye charts, glasses, or outdoor activities. Additionally, the dashboard now features an integrated “message builder” tool, which enables clinicians to combine and refine their chosen tone and theme elements into a cohesive media message. According to some examples, the method includes receiving a first selected set of content attributes for generating the new customized media message at step 710.

According to some examples, the method includes generating, using the trained neural network, a new video content generation module based on the selected set of content attributes, wherein the received selected set are associated with weights for the neural network to utilize generative artificial intelligence (AI) protocols to create the new video content generation module at step 712. The new video template may be generated based on a combination of generative AI models and pre-trained video element libraries, such as animated infographics, 3D animations, or real-world footage. The new video template may then populated with customizable video elements, including text overlays, graphics, and audio tracks, to create a unique and engaging visual narrative that adheres to the specified tone and theme.

According to some examples, the method includes generating, using the new video content generation module, the new customized media message by incorporating multi-modal fusion of facial expression data from a training database based on at least part of the selected set of content attributes, voice matching algorithms that generate an audio track synchronized to video context, and text-to-video synthesis that integrates at least part of the selected set of content attributes at step 714. The system may generate a personalized facial expression animation using the facial expression data from the training database, which is then blended with the pre-rendered video elements to create a dynamic and engaging visual narrative that conveys the tone and theme specified in the selected content attributes. A separate audio track may be generated using voice matching algorithms that analyze the patient's preferred speaking style, tone, and pace, ensuring that the spoken words perfectly match the facial expressions and body language of the animated character. The text-to-video synthesis module may integrate the pre-defined key messages and visual elements into a seamless audio-visual experience, where each word is carefully timed to coincide with the animation and speech patterns of the digital avatar.

The method 700 may also include further includes receiving at least one of second new patient data or second new analytics data including new engagement metrics of the new customized media message, where the patient database includes demographic data and health condition data, and analyzing a set of patient data including at least one of the second new patient data or the second new analytics data for new clustering patterns.

Upon receiving the new engagement metrics of the customized media message, patient data may be analyzed to identify clusters of patients with similar response patterns, interest levels, and engagement behaviors, allowing for more targeted and personalized content recommendations in future iterations. The analysis may be performed using machine learning algorithms that incorporate both categorical and numerical data from the patient database, including demographic information such as age, gender, and location, as well as health condition data like comorbidities and treatment history. By grouping patients into clusters based on their engagement patterns, the system can better understand what resonates with different patient segments and adjust its content strategy to meet those specific needs. For instance, a cluster of patients showing high interest in myopia prevention may be targeted with more educational content, while a cluster of patients exhibiting low engagement may receive personalized reminders or follow-up messages to re-engage them.

The method 700 may also include further includes determining there are no clustering patterns, fine-tuning the trained neural network based on the second new analytics data, where updates the weights are updated based on the new engagement metrics and the new video content generation module is updated based on the updated weights, and generating, using the updated new video content generation module, an updated customized media message by updating the multi-modal fusion of facial expression data, the voice matching algorithms, and the text-to-video synthesis based on at least part of the updated weights.

If no clear clustering patterns emerge from the analysis, the system performs a fine-tuning process to refine the performance of the trained neural network using the second new analytics data, which includes updated engagement metrics and other relevant insights. The weight updates are designed to adapt the model's parameters based on the observed performance improvements or decline in response rates, ensuring that the video content generation module continues to optimize for patient engagement and relevance. As a result, the new weights may be applied to update the video content generation module, which in turn generates an updated customized media message that incorporates these refined parameters. Specifically, the multi-modal fusion of facial expression data may be fine-tuned to better capture the nuances of patient emotions and reactions, and/or the voice matching algorithms may be adjusted to better match the audio patterns and cadence of the spoken words with the patient's expected responses. The text-to-video synthesis module may also be updated to integrate the refined weights in a way that creates a more cohesive and engaging narrative flow between the video elements and audio tracks.

The method 700 may also include further includes determining there are new clustering patterns, retraining a neural network based on the new clustering patterns, where the neural network is adapted to generate video content generation modules that optimize for future engagement by adjusting weights to minimize a divergence between predicted and actual patient response based on new incorporated feedback from a segment of patient data to refine understanding of patient behavior and preferences, and iteratively refine optimization parameters through reinforcement learning,

Upon determining new clustering patterns, the neural network may be retained based on this emerging understanding of patient behavior and preferences. The new neural network may be designed to generate video content generation modules that optimize for future engagement by incorporating feedback from a segment of patient data that formed the clustering patterns. The weights of the neural network may be adjusted to minimize the divergence between predicted and actual patient responses, allowing the model to refine its understanding of what drives patient behavior.

The method 700 may further involve iteratively refining optimization parameters through reinforcement learning, where the model learns to associate certain behaviors or actions with increased or decreased engagement. The retraining process may be a multi-step cycle that involves collecting additional data from the patient segment that formed the clustering patterns, including behavioral and demographic information. The neural network may then be updated with this new data, allowing it to adapt its weights and biases to better capture the nuances of patient behavior. This adaptation enables the model to make more accurate predictions about which patients are likely to engage with certain types of content. The optimization process itself involves assigning rewards or penalties based on the predicted vs. actual engagement outcomes. The method 700 may further involve continuously collecting feedback from patients and updates the model accordingly, allowing it to refine its understanding of what drives patient behavior over time.

The method 700 may further include updating the dashboard interface based on the segment of patient data. In some case, the respective updates include a second new set of selectable suggestions for generating a second new customized media message. The method 700 may also include receiving a second selected set of content attributes for generating the second new customized media message and generating, using the retrained neural network, a second new video content generation module based on the second selected set of content attributes. In some cases, the received second selected set are associated with second weights for the retrained neural network to utilize the generative artificial intelligence (AI) protocols to create the second new video content generation module. The method 700 may further include generating, using the second new video content generation module, the second new customized media message by incorporating new multi-modal fusion of facial expression data from the training database based on at least part of the second selected set of content attributes, voice matching algorithms that generate an audio track synchronized to video context, and text-to-video synthesis that integrates at least part of the second selected set of content attributes.

The method 700 may also include further includes providing, in the dashboard interface, an input field that receives revisions to text spoken by a virtual personal in the new customized media message, fine-tuning the trained neural network based on received revisions, where updates the weights are updated based on the received revisions and the new video content generation module is updated based on the updated weights, and generating, using the updated new video content generation module, an updated customized media message by updating the multi-modal fusion of facial expression data, the voice matching algorithms, and the text-to-video synthesis based on at least part of the updated weights.

Fine-tuning the neural network may use a variety of techniques, including but not limited to: incremental learning, where the weights of the neural network are updated based on the received revisions, without requiring a complete retraining of the model, regularization, where a penalty term is added to the loss function to discourage overfitting and ensure that the model remains generalizable, and batch normalization, where the input data is system normalized to prevent vanishing gradients and improve the stability of the training process. Using the updated new video content generation module, an updated customized media message may be generated to incorporate the latest revisions to the text spoken by the virtual personal. This includes updating the multi-modal fusion of facial expression data from a training database based on at least part of the updated weights. This ensures that the facial expressions displayed in the video are not only personalized but also accurately reflect the patient's emotions and preferences. The system also updates the voice matching algorithms to generate an audio track synchronized to the updated video content, ensuring that the audio is not only personalized but also accurately timed with the visual elements of the video. Finally, the text-to-video synthesis is updated based on at least part of the updated weights, allowing the system to integrate the revised text into the video content in a seamless and engaging manner.

The method 700 may further include providing, in the dashboard interface, an option to adjust a presentation style by a virtual personal in the new customized media message. In some cases, the trained neural network may be fine-tuned based on a selected adjustment to the presentation style. In some cases, the weights are updated based on the selected adjustment and the new video content generation module is updated based on the updated weights. The method 700 may further include generating, using the updated new video content generation module, an updated customized media message by updating the multi-modal fusion of facial expression data, the voice matching algorithms, and the text-to-video synthesis based on at least part of the updated weights. In some cases, the option to adjust is presented alongside a heatmap associated with relevant engagement data based on the patient data. In some cases, the heatmap is multi-dimensional that considers at least one of patient engagement, sentiment analysis, emotional resonance, language style, or tone. The method 700 may further include applying, using a machine-learning model, clustering to heatmap data, detecting outliers in the heatmap data, flagging patients associated with the detected outliers, and providing an option to generate a uniquely tailored media message for the flagged patients.

The method 700 may further include providing, in the dashboard interface, an option to record a voice recording to be spoken by a virtual personal in the new customized media message and converting the voice recording into a set of metadata. In some cases, the method 700 includes processing the set of metadata based on high-dimensional speaker embeddings associated with a target speaker and generating a waveform that represents the acoustic characteristics of the target speaker while preserving phonetic content and prosodic content of the voice recording. The method 700 may further include fine-tuning the trained neural network based on the waveform, where updates the weights are updated based on the waveform and the new video content generation module is updated based on the updated weights. In some cases, the method 700 includes generating, using the updated new video content generation module, an updated customized media message by updating the multi-modal fusion of facial expression data, the voice matching algorithms, and the text-to-video synthesis based on at least part of the updated weights.

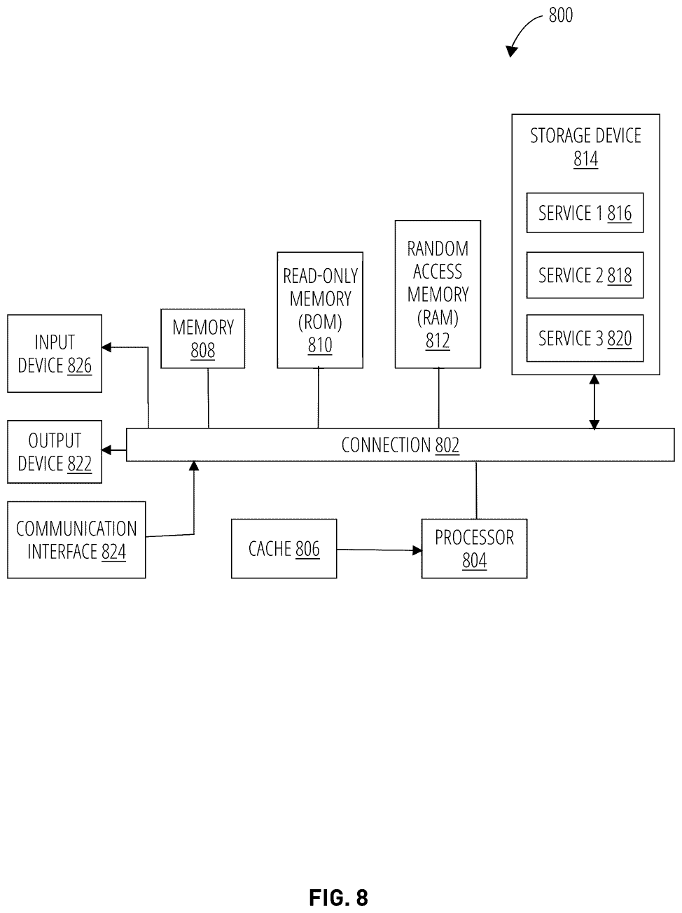

FIG. 8 illustrates a block diagram of an exemplary computing system that may be used to implement an embodiment of the present invention. The example of computer system 800 can be for example any computing device making up 100, or any component thereof in which the components of the system are in communication with each other using connection 802. Connection 802 can be a physical connection via a bus, or a direct connection into processor 804, such as in a chipset architecture. Connection 802 can also be a virtual connection, networked connection, or logical connection.

In some embodiments, computing computer system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing computer system 800 includes at least one processing unit (CPU or processor) 804 and connection 802 that couples various system components including system memory 808, such as read-only memory (ROM) 810 and random access memory (RAM) 812 to processor 804. Computing system 500 can include a cache of high-speed memory 808 connected directly with, in close proximity to, or integrated as part of processor 804.

Processor 804 can include any general purpose processor and a hardware service or software service, such as services 816, 818, and 820 stored in storage devices 814, configured to control processor 804 as well as a special-purpose processor where software instructions are incorporated into the actual processor design. Processor 804 may essentially be a completely self-contained computing system, containing multiple cores or processors, a bus, memory controller, cache, etc. A multi-core processor may be symmetric or asymmetric.

To enable user interaction, computing computer system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computer system 800. Computing system 800 can include communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that when the code that defines such software is executed by the processor 804, it causes the system to perform a function. In some embodiments, a hardware service that performs a particular function can include the software component stored in a computer-readable medium in connection with the hardware components, such as processor 804, connection 802, output device 822, etc., to carry out the function.

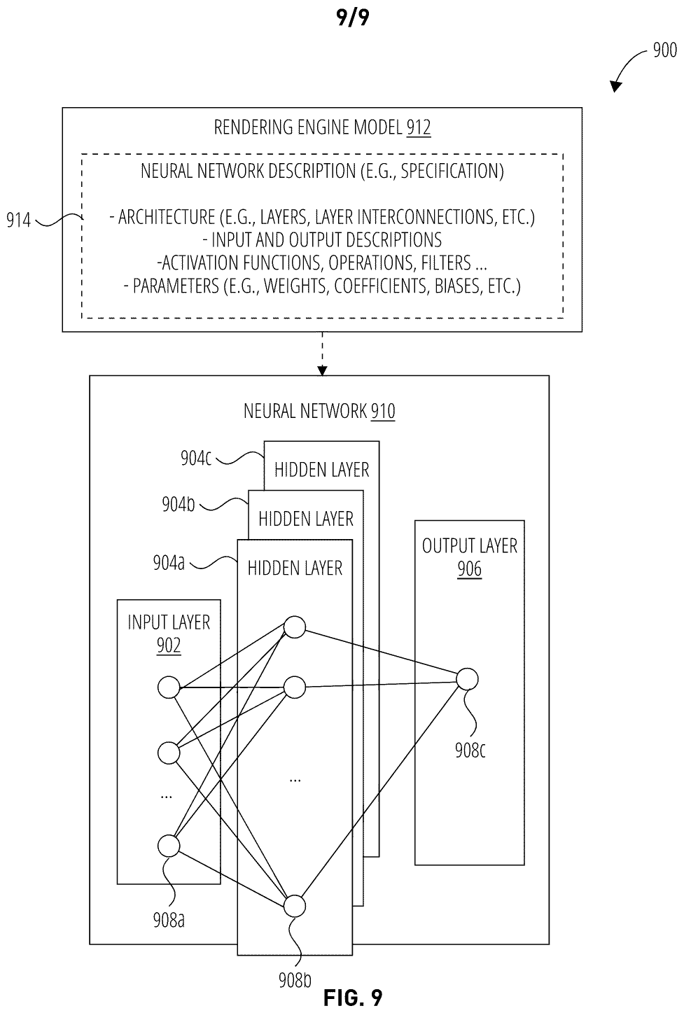

FIG. 9 illustrates an example neural network architecture.

Architecture 900 includes a neural network 910 defined by an example neural network description 914 in a rendering engine model 912. The neural network 910 can represent a neural network implementation of a rendering engine for rendering media data. The neural network description 914 can include a full specification of the neural network 910, including the neural network architecture 900. For example, the neural network description 914 can include a description or specification of the architecture 900 of the neural network 910 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 910 reflects the architecture 900 defined in the input layer 902. In this example, the neural network 910 includes an input layer 902, which includes input data, such as patient data, analytics data, and content attributes. The neural network 910 includes hidden layers 904a through 904 N (collectively “904” hereinafter). The hidden layers 904 can include n number of hidden layers, where n is an integer greater than or equal to one. The number of hidden layers can include as many layers as needed for a desired processing outcome and/or rendering intent.

The neural network 910 further includes an output layer 906 that provides an output (e.g., rendering output) resulting from the processing performed by the hidden layers 904. In one illustrative example, the output layer 906 can provide a customized media message. The neural network 910 in this example is a multi-layer neural network of interconnected nodes. Each node can represent a piece of information. Information associated with the nodes is shared among the different layers and each layer retains information as information is processed. In some cases, the neural network 910 can include a feed-forward neural network, in which case there are no feedback connections where outputs of the neural network are fed back into itself. In other cases, the neural network 910 can include a recurrent neural network, which can have loops that allow information to be carried across nodes while reading in input. Information can be exchanged between nodes through node-to-node interconnections between the various layers.

Nodes of the input layer 902 can activate a set of nodes in the first hidden layer 904a. For example, as shown, each of the input nodes of the input layer 902 is connected to each of the nodes of the first hidden layer 904a. The nodes of the hidden layers hidden layer 904a can transform the information of each input node by applying activation functions to the information. The information derived from the transformation can then be passed to and can activate the nodes of the next hidden layer (e.g., 904b), which can perform their own designated functions. Example functions include convolutional, up-sampling, data transformation, pooling, and/or any other suitable functions. The output of the hidden layer (e.g., 904b) can then activate nodes of the next hidden layer (e.g., 904N), and so on. The output of the last hidden layer can activate one or more nodes of the output layer 906, at which point an output is provided. In some cases, while nodes (e.g., nodes 908a, 908b, 908c) in the neural network 910 are shown as having multiple output lines, a node has a single output and all lines shown as being output from a node represent the same output value. In some cases, each node or interconnection between nodes can have a weight that is a set of parameters derived from training the neural network 910.

For example, an interconnection between nodes can represent a piece of information learned about the interconnected nodes. The interconnection can have a numeric weight that can be tuned (e.g., based on a training dataset), allowing the neural network 910 to be adaptive to inputs and able to learn as more data is processed. The neural network 910 can be pre-trained to process the features from the data in the input layer 902 using the different hidden layers 904 in order to provide the output through the output layer 906. In an example in which the neural network 910 is used to generate a customized media message, the neural network 910 can be trained using training data that includes example historical patient data, historical analytics data, facial expression data, etc. For instance, training images can be input into the neural network 910, which can be processed by the neural network 910 to generate outputs which can be used to tune one or more aspects of the neural network 910, such as weights, biases, etc. In some cases, the neural network 910 can adjust weights of nodes using a training process called backpropagation. Backpropagation can include a forward pass, a loss function, a backward pass, and a weight update. The forward pass, loss function, backward pass, and parameter update is performed for one training iteration.

The process can be repeated for a certain number of iterations for each set of training media data until the weights of the layers are accurately tuned. For a first training iteration for the neural network 910, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 910 is unable to determine low level features and thus cannot make an accurate determination of what the classification of the object might be. A loss function can be used to analyze errors in the output. Any suitable loss function definition can be used. The loss (or error) can be high for the first training dataset (e.g., images) since the actual values will be different than the predicted output.

The goal of training is to minimize the amount of loss so that the predicted output comports with a target or ideal output. The neural network 910 can perform a backward pass by determining which inputs (weights) most contributed to the loss of the neural network 910, and can adjust the weights so that the loss decreases and is eventually minimized. A derivative of the loss with respect to the weights can be computed to determine the weights that contributed most to the loss of the neural network 910. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 910 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 910 can represent any other neural or deep learning network, such as an autoencoder, a deep belief nets (DBNs), a recurrent neural networks (RNNs), etc.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method for generating a customized media content, the method comprising:
receiving a first set of analytics data sent over a communication network, the first set of analytics data including metrics regarding online engagement by a first user device with customized media content that had been generated based on a first set of historical analytics data and a first set of historical data;
training a neural network based on data regarding the first user and the first set of analytics data, wherein the neural network is trained to generate video content generation modules that optimize for increased engagement of video content by adjusting optimization parameters to minimize a divergence between predicted and actual engagement levels and iteratively refining the optimization parameters over time;
generating a new video content generation module based on use of the trained neural network to analyze a selected set of content attributes, wherein the neural network generates the new video content generation module in accordance with generative artificial intelligence (AI) protocols; and
generating new customized media content using the new video content generation module to:
incorporate multi-modal fusion of facial expression data from a database into video content for the new customized media content based on the selected set of content attributes,
use voice matching algorithms to generate an audio track for the video content, synchronize the audio track to the video content, and
integrate one or more of the selected set of content attributes into the new customized media content.

2. The computer-implemented method of claim 1, further comprising:
generating a dashboard interface based on the first set of analytics data, wherein the dashboard interface displays a plurality of selectable content attributes; and
receiving a selection as to the set of content attributes via the online dashboard interface.

3. The computer-implemented method of claim 1, further comprising:
receiving data regarding one or more other users including engagement metrics by each of the other users with the new customized media content; and
analyzing the received data for one or more new clustering patterns.

4. The computer-implemented method of claim 3, further comprising:
determining that there are no new clustering patterns associated with the received data regarding an initial one of the other users;
fine-tuning the trained neural network based on the received data regarding the initial other user, wherein fine-tuning the trained neural network includes updating the weights of the new video content generation module; and
generating updated customized media content using the new video content generation module after the weights are updated.

5. The computer-implemented method of claim 3, further comprising:
determining that there are one or more new clustering patterns associated with the received data regarding one of the other users, the new clustering patterns associated with a segment of user data; and
retraining the neural network based on the new clustering patterns and the segment of user data.

6. The computer-implemented method of claim 5, further comprising:
updating the dashboard interface based on the segment of patient data; and
generating additional new customized media content using a second new video content generation module generated by the retrained neural network and a second set of content attributes selected from the updated dashboard.

7. The computer-implemented method of claim 1, further comprising:
providing an input field within the dashboard interface for receiving revisions to an audio track associated with speech by a virtual persona within the new customized media content; and
fine-tuning the trained neural network based on one or more revisions received via the input field.

8. The computer-implemented method of claim 1, wherein the input field is associated with one or more options for adjusting a presentation style of the virtual persona, and wherein the received revisions include a selection of one of the options.

9. The computer-implemented method of claim 8, further comprising generating a heatmap display that illustrates engagement data with a set of customized media content.

10. The computer-implemented method of claim 9, wherein the heatmap maps the engagement data along a plurality of dimensions including at least one of user engagement level, sentiment analysis, emotional resonance, language style, or tone.

11. The computer-implemented method of claim 1, further comprising:
using a machine-learning model to identify one or more clusters in engagement data associated with the customized media content;
flagging one or more outlier users relative to the identified clusters; and
providing an option within a dashboard interface regarding generation of uniquely-tailored media content specific to one or more of the the flagged outlier users.

12. The computer-implemented method of claim 1, wherein the selected set of content attributes includes a selected target speaker and a selected option to record a voice recording for a virtual persona of the new customized media content, and further comprising:
capturing the voice recording in associated with a set of metadata;
processing the set of metadata based on high-dimensional speaker embeddings associated with a target speaker;
generating a waveform that represents acoustic characteristics of the target speaker while preserving phonetic content and prosodic content of the voice recording; and
fine-tuning the trained neural network based on the generated waveform.

13. A system for generating a customized media message, the system comprising:
a communication interface that communicates over a communication network to receive a first set of analytics data including metrics regarding online engagement by a first user device with customized media content that had been generated based on a first set of historical analytics data and a first set of historical data; and
a processor that executes instructions stored in memory, wherein the processor executes the instructions to:
train a neural network based on data regarding the first user and the first set of analytics data, wherein the neural network is trained to generate video content generation modules that optimize for increased engagement of video content by adjusting optimization parameters to minimize a divergence between predicted and actual engagement levels and iteratively refining the optimization parameters over time;
generate a new video content generation module based on use of the trained neural network to analyze a selected set of content attributes, wherein the neural network generates the new video content generation module in accordance with generative artificial intelligence (AI) protocols; and
generate new customized media content using the new video content generation module to:
incorporate multi-modal fusion of facial expression data from a database into video content for the new customized media content based on the selected set of content attributes,
use voice matching algorithms to generate an audio track for the video content,
synchronize the audio track to the video content, and
integrate one or more of the selected set of content attributes into the new customized media content.

14. The system of claim 3, wherein the processor executes further instructions to:
generate a dashboard interface based on the first set of analytics data, wherein the dashboard interface displays a plurality of selectable content attributes; and
receive a selection as to the set of content attributes via the online dashboard interface.

15. The system of claim 13, wherein the communication interface further receives data regarding one or more other users including engagement metrics by each of the other users with the new customized media content, and wherein the processor executes further instructions to analyze the received data for one or more new clustering patterns.

16. The system of claim 15, wherein the processor executes further instructions to:
determine that there are no new clustering patterns associated with the received data regarding an initial one of the other users;
fine-tune the trained neural network based on the received data regarding the initial other user, wherein fine-tuning the trained neural network includes updating the weights of the new video content generation module; and
generate updated customized media content using the new video content generation module after the weights are updated.

17. The system of claim 15, wherein the processor executes further instructions to:
determine that there are one or more new clustering patterns associated with the received data regarding one of the other users, the new clustering patterns associated with a segment of user data; and
retrain the neural network based on the new clustering patterns and the segment of user data.

18. The system of claim 17, wherein the processor executes further instructions to:
update the dashboard interface based on the segment of patient data; and
generate additional new customized media content using a second new video content generation module generated by the retrained neural network and a second set of content attributes selected from the updated dashboard.

19. The system of claim 13, wherein the processor executes further instructions to:
provide an input field within the dashboard interface for receiving revisions to an audio track associated with speech by a virtual persona within the new customized media content; and
fine-tune the trained neural network based on one or more revisions received via the input field.

20. The system of claim 13, wherein the input field is associated with one or more options for adjusting a presentation style of the virtual persona, and wherein the received revisions include a selection of one of the options.

21. The system of claim 20, wherein the processor executes further instructions to generate a heatmap display that illustrates engagement data with a set of customized media content.

22. The system of claim 21, wherein the heatmap maps the engagement data along a plurality of dimensions including at least one of user engagement level, sentiment analysis, emotional resonance, language style, or tone.

23. The system of claim 13, wherein the processor executes further instructions to:
use a machine-learning model to identify one or more clusters in engagement data associated with the customized media content;
flag one or more outlier users relative to the identified clusters; and
provide an option within a dashboard interface regarding generation of uniquely-tailored media content specific to one or more of the the flagged outlier users.

24. The system of claim 1, wherein the selected set of content attributes includes a selected target speaker and a selected option to record a voice recording for a virtual persona of the new customized media content, and wherein the processor executes further instructions to:
capture the voice recording in associated with a set of metadata;
process the set of metadata based on high-dimensional speaker embeddings associated with a target speaker;
generate a waveform that represents acoustic characteristics of the target speaker while preserving phonetic content and prosodic content of the voice recording; and
fine-tune the trained neural network based on the generated waveform.

25. A non-transitory computer readable medium comprising instructions, the instructions, when executed by a computing system, cause the computing system to:
receiving a first set of analytics data sent over a communication network, the first set of analytics data including metrics regarding online engagement by a first user device with customized media content that had been generated based on a first set of historical analytics data and a first set of historical data;
training a neural network based on data regarding the first user and the first set of analytics data, wherein the neural network is trained to generate video content generation modules that optimize for increased engagement of video content by adjusting optimization parameters to minimize a divergence between predicted and actual engagement levels and iteratively refining the optimization parameters over time;
generating a new video content generation module based on use of the trained neural network to analyze a selected set of content attributes, wherein the neural network generates the new video content generation module in accordance with generative artificial intelligence (AI) protocols; and
generating new customized media content using the new video content generation module to:
incorporate multi-modal fusion of facial expression data from a database into video content for the new customized media content based on the selected set of content attributes,
use voice matching algorithms to generate an audio track for the video content, synchronize the audio track to the video content, and
integrate one or more of the selected set of content attributes into the new customized media content.
